(19) United States
(12) Patent Application Publication
(10) Pub. No.: US 2008/0249855 A1
(43) Pub. Date: Oct. 9, 2008

(54) System for generating advertising creatives

(75) Inventors: Robert J. Collins, Brookfield, NH (US); Paul J. Apodaca, Carlsbad, CA (US); Adam J. Wand, Carlsbad, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc.

(21) Appl. No.: 11/732,688

(22) Filed: Apr. 4, 2007

(51) Int. Cl. G06Q 30/00

(52) U.S. Cl. 705/14

(57) ABSTRACT

A system is described for generating advertising creatives. The system may include a processor and a memory. The memory may be operatively connected to the processor and may store an ad group of an advertiser, a first set of creative components relating to the ad group, a second set of creative components relating to the ad group, a set of matched groups of creative components, and a set of destination URLs relating to the ad group. The processor may identify the ad group, the first set of creative components, the second set of creative components and the set of destination URLs, match each creative component in the first set of creative components to each creative component in the second set of creative components to create a set of matched groups of creative components and match each matched group of creative components to each destination URL in the set of destination URLs thereby generating advertising creatives.

### TECHNICAL FIELD

The present description relates generally to a system and method, generally referred to as a system, for generating advertising creatives, and more particularly, but not exclusively, to generating advertising creatives to be used in an online advertising system.

### BACKGROUND

Online advertising may be an important source of revenue for enterprises engaged in electronic commerce. A number of different kinds of page-based online advertisements are currently in use, along with various associated distribution requirements, advertising metrics, and pricing mechanisms. Processes associated with technologies such as Hypertext Markup Language (HTML) and Hypertext Transfer Protocol (HTTP) may enable a page to be configured to contain a location for inclusion of an advertisement. An advertisement may be selected for display each time the page is requested, for example, by a browser or server application.

An online advertiser may only pay for a displayed online advertisement if a user clicks through the online advertisement. Whether a user clicks through an online advertisement may be related to the form and/or content of the online advertisement and not the site the advertisement links to. Some systems may allow an online advertiser to maintain more than one version, or creative, of an advertisement. The creatives may differ slightly in form and/or content. The weight optimizer may serve users the advertising creative they may be most likely to click through on.

However, the efficacy of such a system may depend on the number of distinct creatives submitted by an online advertiser. The process of creating several creatives may be time consuming and difficult and may deter online advertisers from creating more than one creative. If an advertisement lacks several creatives, the effectiveness of such a system may be diminished or rendered altogether inoperative.

### SUMMARY

A system for generating advertising creatives may include a processor, and a memory. The memory may be operatively connected to the processor and may store an ad group, a first set of creative components a second set of creative components, a set of matched groups of creative components, and a set of destination URLs. The processor may identify the ad group, the first set of creative components, the second set of creative components and the set of destination URLs. The processor may match each component in the first set of creative components to each component in the second set of creative components to create a set of matched groups of creative components. The processor may match each matched group of creative components to each destination URL in the set of destination URLs to generate advertising creatives.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for generating advertising creatives.

FIG. 2 is block diagram of a simplified view of a network environment implementing the system of FIG. 1 or other systems for generating advertising creatives.

FIG. 3 illustrates a pod of an advertisement campaign management system implementing the system of FIG. 1, or other systems for generating advertising creatives.

FIG. 4 is a block diagram of an advertisement campaign data structure according to the advertisement campaign management system of FIG. 3, or other systems for managing advertisement campaigns.

FIG. 5 is block diagram of a process flow of the system of FIG. 1, or other systems for generating advertising creatives.

FIG. 6 is a flowchart illustrating operations of the system of FIG. 1, or other systems for generating advertising creatives.

FIG. 7 is a table displaying data demonstrating creative components in the system of FIG. 1, or other systems for generating advertising creatives.

FIG. 8 is a screenshot of a revenue generator's creative suggestion tool screen in the system of FIG. 1, or other systems for generating advertising creatives.

FIG. 9 is a screenshot of a revenue generator's creative suggestion tool results screen in the system of FIG. 1, or other systems for generating advertising creatives.

FIG. 10 is a block diagram of a system implementing the system of FIG. 1, or other systems for generating advertising creatives for facilitating display and management of advertisement campaign information.

FIG. 11 is a flow diagram of a method for managing advertisement campaign information.

FIG. 12 is a flow diagram of a method for managing advertisement campaign information.

FIG. 13 is a block diagram of a system for interacting with an application program interface (“API”) of an advertisement campaign management system implementing the system of FIG. 1, or other systems for generating advertising creatives.

FIG. 14 is an illustration a general computer system that may be used in the system of FIG. 1, or other systems for generating advertising creatives.

### DETAILED DESCRIPTION

A system and method, generally referred to as a system, relate to generating advertising creatives, and more particularly, but not exclusively, to generating advertising creatives for online advertisers utilizing a system supporting alternative advertisement functionality. The principles described herein may be embodied in many different forms. An online advertiser using a pay for placement advertising system implementing alternative advertising functionality may benefit from having multiple creatives for each ad group. The system may assist an advertiser to quickly and efficiently generate multiple creatives. The system may use content matching to determine the relevance of the generated creatives to the site of the advertiser and/or the search keywords bid on for the ad group

The system may generate advertising creatives and suggest the advertising creatives to the advertiser. The advertising creatives may include one or more creative components. The creative components may include a combination of one or more of the title of the advertisement, the description of the advertisement, the destination site of the advertisement, the terms bid on, any user generated creatives and/or the content of the destination site. The system may generate and process the creative components. The advertiser may review the suggested creatives and may filter out the creatives that are irrelevant or otherwise undesirable.

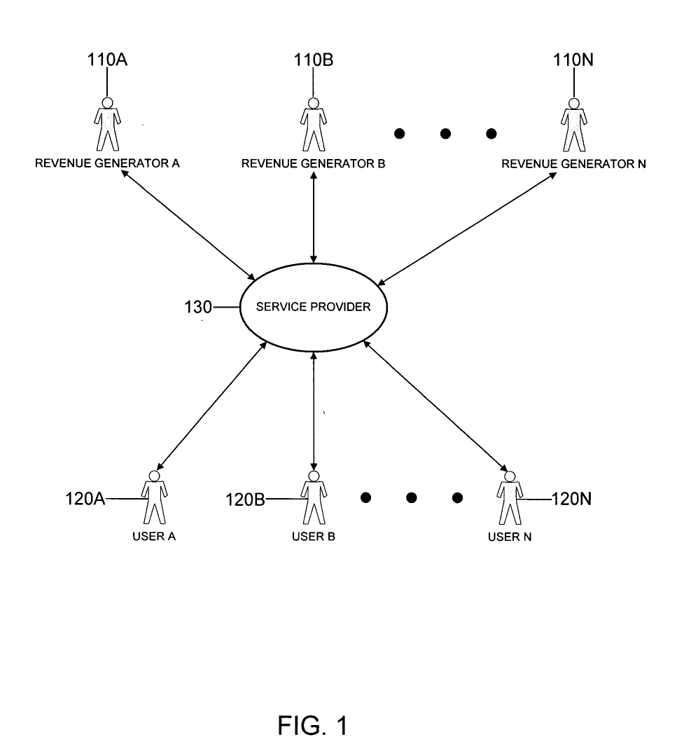

FIG. 1 provides a general overview of a system 100 for generating advertising creatives. Not all of the depicted components may be required, however, and some implementations may include additional components. Variations in the arrangement and type of the components may be made without departing from the spirit or scope of the claims as set forth herein. Additional, different or fewer components may be provided.

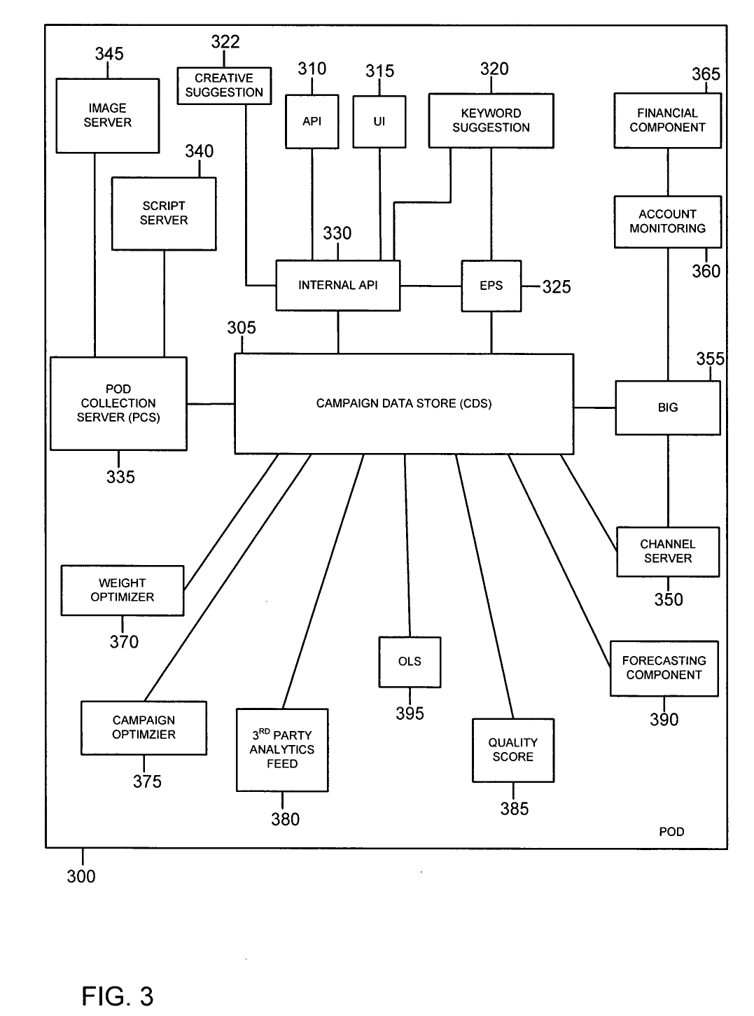

The system 100 may include one or more revenue generators 110A-N, such as advertisers, a service provider 130, such as a portal, and one or more users 120A-N, such as web surfers or consumers. The service provider 130 may implement an advertising campaign management system, which may provide one or more pods, as shown in FIG. 3 and discussed in more detail below. The revenue generators 110A-N may pay the service provider 130 to display advertisements, such as on-line advertisements on a network such as the Internet. The payments may be based on various factors, such as the number of times an advertisement may be displayed to the users 120A-N and/or the number of times one of the users 120A-N clicks through the advertisement to the revenue generator's web site. The users 120A-N may be consumers of goods or services who may be searching for a business such as the business of one of the revenue generators 110A-N. The users 120A-N may supply information describing themselves to the service provider 130, such as the location, gender, or age of the users 120A-N, or generally any information that may be required for the users 120A-N to utilize the services provided by the service provider 130.

In the system 100, the revenue generators 110A-N may interact with the service provider 130, such as via a web application. The revenue generators 110A-N may send information, such as billing, website and advertisement information, to the service provider 130 via the web application. The web application may include a web browser or other application such as any application capable of displaying web content. The application may be implemented with a processor such as a personal computer, personal digital assistant, mobile phone, or any other machine capable of implementing a web application. The users 120A-N may also interact individually with the service provider 130, such as via a web application. The users 120A-N may interact with the service provider 130 via a web based application or a standalone application. The service provider 130 may communicate data to the revenue generators 110A-N and the users 120A-N over a network. The following examples may refer to a revenue generator A 110A as an online advertiser; however the system 100 may apply to any revenue generators 110A-N who may utilize advertising creatives.

In operation, one of the revenue generators 110A-N, such as revenue generator A 110A, may provide information to the service provider 130. This information may relate to the transaction taking place between the revenue generator A 110A and the service provider 130, or may relate to an account the revenue A 110A generator maintains with the service provider 130. In the case of a revenue generator A 110A who is an online advertiser, the revenue generator A 110A may provide initial information necessary to open an account with the service provider 130.

A revenue generator A 110A who is an online advertiser may maintain several accounts with the service provider 130. For each account the revenue generator A 110A may maintain several advertising campaigns, such as an MP3 player campaign, a car campaign, or any other distinguishable category of products and/or services. Each campaign may include one or more ad groups. The ad groups may further distinguish the category of products and/or services represented in the advertising campaign, such as by search tactic, performance parameter, demographic of user, family of products, or almost any other parameter desired by the revenue generators 110A-N. For example, if the advertising campaign is for MP3 Players, there may be an ad group each brand of MP3 players, such as APPLE IPOD or MICROSOFT ZUNE. Allowing the revenue generators 110A-N to determine their own ad groups may allow the service provider 130 to provide more useful information to the revenue generators 110A-N. The revenue generators 110A-N may thereby display, manage, optimize, or view reports on, advertisement campaign information in a manner most relevant to a revenue generator, such as the revenue generator A 110A.

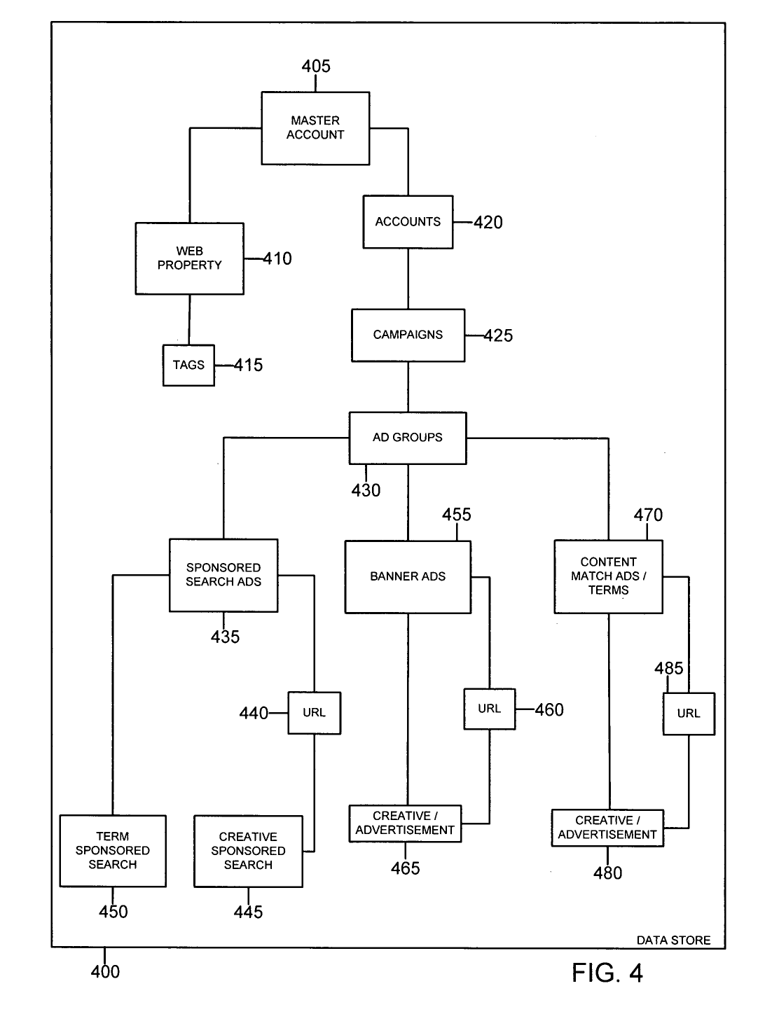

The ad groups may include one or more listings. A listing may include a product name, a description, one or more search keywords, an advertisement, a destination URL, and a bid amount. A listing may represent an association between the one or more search keywords identified by the revenue generator A 110A, and an advertisement of the revenue generator A 110A. A more detailed description of one such data hierarchy may be described in more detail in FIG. 4.

The product name may be the name of the product being advertised, such as “JEEP WRANGLER.” The description may describe the product being advertised. For example, if GENERAL MOTORS wished to advertise a GENERAL MOTORS JEEP WRANGLER, the listing may have a description of “GENERAL MOTORS JEEP WRANGLER,” “JEEP WRANGLER,” or “5 PASSENGER JEEP WRANGLER.” The description may be separated into two independent half-descriptions.

The keywords may represent one or more search terms that the revenue generator A 110A wishes to associate their advertisement with. When a user A 120A searches for one of the listing's keywords, the advertisement of the revenue generator A 110A may be displayed on the search results page. For example, a revenue generator A 110A, such as GENERAL MOTORS, may desire to target an online advertisement for a GENERAL MOTORS JEEP WRANGLER to users 120A-N searching for the keywords “JEEP”, “WRANGLER”, or “JEEP WRANGLER”. GENERAL MOTORS may place a bid with the service provider 130 for the search keywords “JEEP”, “WRANGLER”, and “JEEP WRANGLER” and may associate the online advertisement for a GENERAL MOTORS JEEP WRANGLER with the keywords. The advertisement of the revenue generator A 110A may be displayed when one of the users 120A-N searches for the keywords “JEEP”, “WRANGLER”, or “JEEP WRANGLER”.

An advertisement may represent the data the revenue generator A 110A wishes to be displayed to a user A 120A when the user A 120A searches for one of the listing's keywords. An advertisement may include a combination of the description and the title. The ad groups may each contain several different advertisements, which may be referred to as creatives. Each of the individual advertisements in an ad group may be associated with the same keywords. The advertisements may differ slightly in creative aspects or may be targeted to different demographics of the users 120A-N.

The service provider 130 may implement a system that rotates through which advertisements in an ad group are displayed to the users 120A-N. The system may collect data regarding whether a user, such as the user A 120A, clicks on an particular advertisement. The system may use the data to determine the click through rate for each of the advertisements in an ad group. The click through rate may be represented by the ratio of the number of times an advertisement was clicked on by the users 120A-N as compared to the number of times the advertisement was displayed to the users 120A-N. The system may display the advertisements in the ad group with higher click through rates more often than the advertisements with lower click through rates in the ad group. Alternatively or in addition, the system may further refine the click, through rates of the advertisements creatives based on the demographic of the users 120A-N or any other characteristic that may assist in determining which advertisement may be the most effective. One such ad rotation system may be described in more detail in FIG. 3 below.

Alternatively or in addition to the click through rate the system may use other metrics associated with online advertising to determine which advertisements in an ad group to display more or less frequently. These metrics may include revenue per click through, number of conversions, conversion rates, revenue from conversions, revenue per conversion, net revenue per conversion, or generally any metric capable of indicating the effectiveness of an advertisement.

The revenue per click through may be calculated by dividing the total number of click throughs by the amount of revenue generated by the users 120A-N as a result of the click throughs. The number of conversions may be the total conversions for the advertisement. A conversion may occur when a one of the users, such as the user A 120A, takes a desired action after clicking through on an advertisement of one of the revenue generators, such as the revenue generator A 110A. The desired action may be submitting a sales lead, making a purchase, viewing a key page of the site, downloading a whitepaper, or any other measurable action. The conversion rate may be the percentage of unique users 120A-N who take the desired action after clicking through on the advertisement of the revenue generator A 110A.

If the desired action is a purchase by the users 120A-N, then the metric revenue from conversions may indicate the amount of revenue generated as a result of the conversions. Revenue per conversion may be revenue from conversions divided by the number of conversions. The net revenue per conversion may be calculated by subtracting the total advertising costs for the advertisement from the revenue from conversions of the advertisement and dividing the result by the number of conversions from the advertisement.

The destination URL may represent the link the revenue generator A 110A wishes a user A 120A to be directed to upon clicking on the advertisement of the revenue generator A 110A, such as the home page of the revenue generator A 110A. The bid amount may represent a maximum amount the revenue generator A 110A may be willing to pay each time a user A 120A may click on the advertisement of the revenue generator A 110A or each time the advertisement of the revenue generator A 110A may be shown to a user A 120A.

There may be some instances where multiple revenue generators 110A-N may have bid on the same search keyword. The service provider 130 may serve to the users 120A-N the online advertisements that the users 120A-N may be most likely to click on. For example, the service provider 130 may include a relevancy assessment to determine the relevancy of the multiple online advertisements to the search keyword. The more relevant an advertisement may be to the keyword the more likely it may be that the user A 120A may click on the advertisement. Exemplary ways to determine relevance are described in more detail below.

When one of the users 120A-N, such as the user A 120A, interacts with the service provider 130, such as by searching for a keyword, the service provider 130 may retain data describing the interaction with the user A 120A. The saved data may include the keyword searched for, the geographic location of the user A 120A, and the date/time the user A 120A interacted with the service provider 130. The data may also generally include any data available to the service provider 130 that may assist in describing the interaction with the user A 120A, or describing the user A 120A. The service provider 130 may also store data that indicates whether an advertisement of one of the revenue generators 110A-N, such as the revenue generator A 110A was displayed to the user A 120A, and whether the user A 120A clicked on the advertisement.

The service provider 130 may already have information relating to the geographic location of the user A 120A and other information describing the user A 120A, such as gender, age, etc. This information may have been previously supplied to the service provider 130 by the user A 120A. Alternatively or in addition the service provider 130 may obtain the location of the user A 120A based on the IP address of the user A 120A. The service provider 130 may use a current date/time stamp to store the date/time when the user A 120A interacted with the service provider 130.

The service provider 130 may generate reports based on the data collected from the user interactions and communicate the reports to the revenue generators 110A-N to assist the revenue generators 110A-N in measuring the effectiveness of their online advertising. The reports may indicate the number of times the users 120A-N searched for the keywords bid on by the revenue generators 110A-N, the number of times each advertisement of the ad groups of the revenue generators 110A-N was displayed to the users 120A-N, the number of times the users 120A-N clicked through on each advertisement of the ad groups of the revenue generators 110A-N. The reports may also generally indicate any data that may assist the revenue generators 110A-N in measuring the effectiveness of their online advertising or in effectively managing their advertisements.

The reports may further include sub-reports that segment the data into more specific categories, including the time intervals when the interactions occurred, such as weeknights primetime, weekends, etc., the demographics of the users 120A-N, such as men ages 18-34, the location of the users 120A-N. The reports may also generally include any other data categorization that may assist the revenue generators 110A-N in determining the effectiveness of their online advertising.

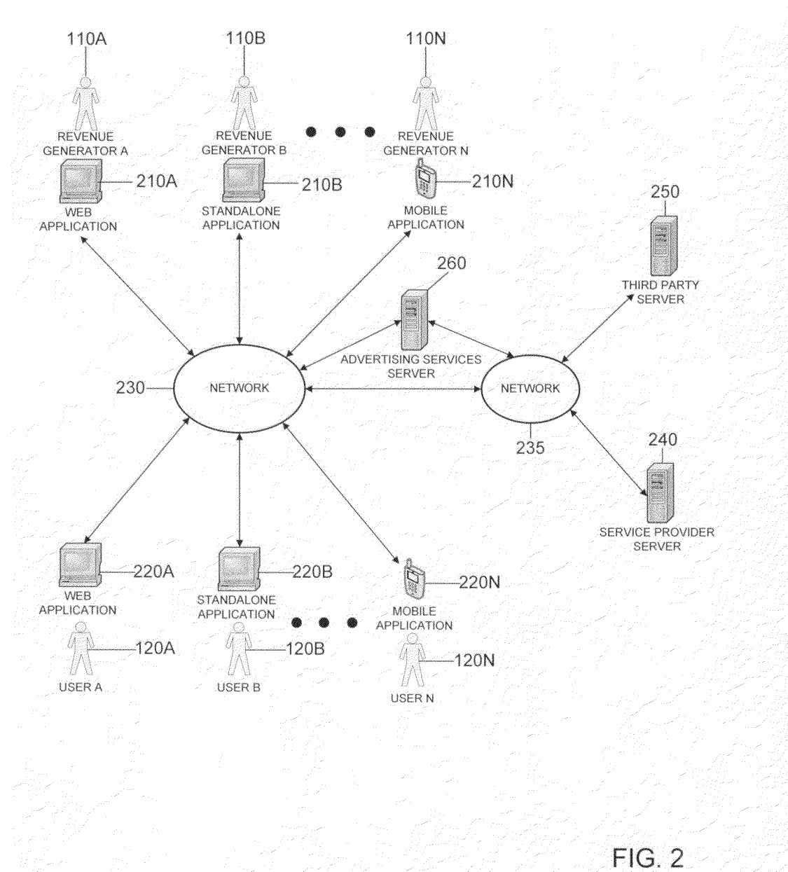

FIG. 2 provides a simplified view of a network environment implementing the system of FIG. 1 or other systems for generating advertising creatives. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include one or more web applications, standalone applications and mobile applications 210A-N, which may be collectively or individually referred to as client applications for the revenue generators 110A-N. The system 200 may also include one or more web applications, standalone applications, mobile applications 220A-N, which may collectively be referred to as client applications for the users 120A-N, or individually as a user client application. The system 200 may also include a network 230, a network 235, the service provider server 240, a third party server 250, and an advertising services server 260.

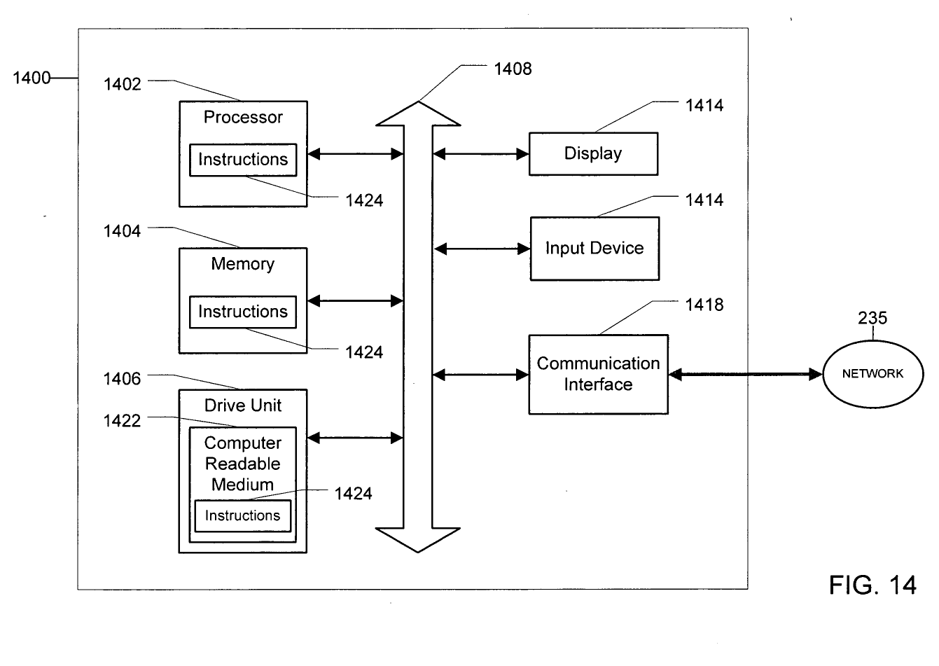

Some or all of the advertisement services server 260, service provider server 240, and third-party server 250 may be in communication with each other by way of network 235 and may be the system or components described below in FIG. 14. The advertisement services server 260, third-party server 250 and service provider server 240 may each represent multiple linked computing devices. Multiple distinct third party servers, such as the third-party server 250, may be included in the system 200.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The revenue generators 110A-N may use a web application 210A, standalone application 210B, or a mobile application 210N, or any combination thereof, to communicate to the service provider server 240, such as via the networks 230, 235. Similarly, the users 120A-N may use a web application 220A, a standalone application 220B, or a mobile application 220N to communicate to the service provider server 240, via the networks 230, 235.

The service provider server 240 may communicate to the revenue generators 110A-N via the networks 230, 235, through the web applications, standalone applications or mobile applications 210A-N. The service provider server 240 may also communicate to the users 120A-N via the networks 230, 235, through the web applications, standalone applications or mobile applications 220A-N.

The web applications, standalone applications and mobile applications 210A-N, 220A-N may be connected to the network 230 in any configuration that supports data transfer. This may include a data connection to the network 230 that may be wired or wireless. Any of the web applications, standalone applications and mobile applications 210A-N, 220A-N may individually be referred to as a client application. The web applications 210A, 220A may run on any platform that supports web content, such as a web browser or a computer, a mobile phone, personal digital assistant (PDA), pager, network-enabled television, digital video recorder, such as TIVO®, automobile and/or any appliance capable of data communications.

The standalone applications 210B, 220B may run on a machine that may have a processor, memory, a display, a user interface and a communication interface. The processor may be operatively connected to the memory, display and the interfaces and may perform tasks at the request of the standalone applications 210B, 220B or the underlying operating system. The memory may be capable of storing data. The display may be operatively connected to the memory and the processor and may be capable of displaying information to the revenue generator B 110B or the user B 120B. The user interface may be operatively connected to the memory, the processor, and the display and may be capable of interacting with a user A 120A or a revenue generator A 110A. The communication interface may be operatively connected to the memory, and the processor, and may be capable of communicating through the networks 230, 235 with the service provider server 240, third party server 250 and advertising services server 260. The standalone applications 210B, 220B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile applications 210N, 220N may run on any mobile device that may have a data connection. The data connection may be a cellular connection, a wireless data connection, an internet connection, an infra-red connection, a Bluetooth connection, or any other connection capable of transmitting data.

The service provider server 240 may include one or more of the following: an application server, a data source, such as a database server, a middleware server, and an advertising services server. The service provider server 240 may co-exist on one machine or may be running in a distributed configuration on one or more machines. The service provider server 240 may collectively be referred to as the server. The service provider server 240 may receive requests from the users 120A-N and the revenue generators 110A-N and may serve pages to the users 120A-N and the revenue generators 110A-N based on their requests. Furthermore the service provider server 240 may implement one or more pods, as shown in FIG. 3 and discussed in more detail below.

The third party server 250 may include one or more of the following: an application server, a data source, such as a database server, a middleware server, and an advertising services server. The third party server 250 may co-exist on one machine or may be running in a distributed configuration on one or more machines. The third party server 250 may receive requests from the users 120A-N and the revenue generators 110A-N and may serve pages to the users 120A-N and the revenue generators 110A-N based on their requests.

The advertising services server 260 may provide a platform for the inclusion of advertisements in pages, such as web pages. The advertisement services server 260 may be used for providing advertisements that may be displayed to the users 120A-N.

The service provider server 240, the third party server 250 and the advertising services server 260 may be one or more computing devices of various kinds, such as the computing device in FIG. 14. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web applications 210A, 210A may employ HTTP to request information, such as a web page, from a web server, which may be a process executing on the service provider server 240 or the third-party server 250.

There may be several configurations of database servers, application servers, middleware servers and advertising services servers included in the service provider server 240 or the third party server 250. Database servers may include MICROSOFT SQL SERVER, ORACLE, IBM DB2 or any other database software, relational or otherwise. The application server may be APACHE TOMCAT, MICROSOFT IIS, ADOBE COLDFUSION, YAPACHE or any other application server that supports communication protocols. The middleware server may be any middleware that connects software components or applications. The application server on the service provider server 240 or the third party server 250 may serve pages, such as web pages to the users 120A-N and the revenue generators 110A-N. The advertising services server may provide a platform for the inclusion of advertisements in pages, such as web pages. The advertising services server 260 may also exist independent of the service provider server 240 and the third party server 250. The advertisement services server 260 may be used for providing advertisements that may be displayed to users 120A-N on pages, such as web pages.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

FIG. 3 illustrates a pod of an advertisement (“ad”) campaign management system implementing the system of FIG. 1, or other systems for generating advertising creatives. One or more pods may be part of an advertising campaign management system implemented by the service provider 130. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The pod 300 may include a plurality of software components and data for facilitating the planning, management, optimization, delivery, communication, and implementation of advertisements and ad campaigns, as well as for storing and managing accounts of the revenue generators 110A-N. A pod 300 may include a campaign data store (“CDS”) 305 that may store revenue generator account information. Application Program Interfaces (“APIs”) 310 and User Interfaces (“UI”) 315 may be used for reading data from and writing data to the campaign data store 305. Internal APIs 330 may provide shared code and functions between the API and UI, and may facilitate interface with the campaign data store 305. A keyword suggestion component 320 may assist revenue generators 120A-N in searching for available search terms. A creative suggestion component 322 may assist revenue generators 110A-N in generating advertisements. An editorial processing system (“EPS”) 325 may be provided to review content of all new ads. If more than one pod is utilized, a pod collection server (“PCS”) 335 may determine which pod the collected ad campaign performance data should be routed to. A script server 340 may provide scripts for the collection of data indicative of the customer browsing sessions. An image server 345 may receive and process data indicative of the customer browsing sessions from the customer web browsers.

The pod 300 may also include a channel server 350 which may be operative to receive data from one or more advertising channels. A business information group (“BIG”) 355 may provide analysis and filtering of raw click data coming from the advertising channels through the channel server 350. An account monitoring component 360 may monitor budgets allocated for each ad campaign. A financial component 365 may provide for planning and budgeting ad campaign expenses. A weight optimizer 370 may be operative to optimize individual ad performance. A campaign optimizer 375 may be provided to optimize performance of the ad campaign. A third-party analytical feed component 380 is provided to handle the incoming ad performance data from the third-party sources. A quality score component 385 may provide another metric for measuring individual ad performance. A forecast component 390 may be an analytical tool for predicting keywords trends. Finally, an online sign-up (“OLS”) component 395 may provide heightened security services for online transactions involving exchange of moneys.

The CDS 305 may be the main data store of a pod 300. The CDS 305 may store ad campaign account data, including account access and permission lists, user information, advertisements, data collected from advertiser websites indicative of customer browsing sessions, raw click data received from the advertising channels, third party analytical feeds, ad campaign performance data generated by the system, ad campaign optimization data, including budgets and business rules, etc. The CDS 305 may store one or more account data structures as illustrated in FIG. 4 and described in greater detail below.

Data in the CDS 305 may be stored and accessed according to various formats, such as a relational format or flat-file format. The CDS 305 may be managed using various known database management techniques, such as, for example, SQL-based and Object-based. At the physical level, the CDS 305 may be implemented using combinations of one or more of magnetic, optical or tape drives. The CDS 305 may have one or more back up databases that may be used to serve the pod 300 during downtime of the CDS 305.

A pod 300 may expose one or more APIs 310 and UIs 315 which may utilized by the revenue generators 110A-N, to access services of the ad campaign management system, such as for reading data from and writing data to the campaign data store 305. The APIs 310 and UIs 315 may be also provided through a distro component described in detail in U.S. patent application Ser. No. 11/324,129, titled “System and Method for Advertisement Management”, filed Dec. 30, 2005, the entirety of which is hereby incorporated herein by reference. The revenue generators 110A-N may use the APIs 310, which may include XML-based APIs, to allow access to the ad campaign management system and data contained therein. The UI 315 may include a website or web application(s), such as the web application 210A, the standalone application 210B, or the mobile application 210N, for enabling user access to the ad campaign management system. The pod 300 may utilize internal APIs 330, which may be shared code and functions between the APIs 310 and UI 315, which may facilitate interaction with the campaign data store 305.

The above-described user and application program interfaces may be used to facilitate management and optimization of ad campaigns, which include, but may not be limited to, management of listings associated with an auction-based search-term related sponsored search results listings marketplace. For example, the revenue generators 110A-N may use these interfaces to access ad campaign information and ad campaign performance information saved in the ad campaign data store 305, search the information, analyze the information, obtain reports, summaries, etc. The revenue generators 110A-N may also change listings or bidding strategies using these interfaces. The changes may be updated in the campaign data store 305. Furthermore, these interfaces may be used to perform comparisons of the performance of components of ad campaigns, such as performance of particular listings, search terms, creatives, channels, tactics, etc.

While functionality and use of application program interfaces of the pod 300 may be described with reference to an auction-based search term-related sponsored listings context, these interfaces may be used with regard to off-line or non-sponsored search ad campaigns and ad campaign performance, or combinations of on-line and off-line ad campaigns information, as well.

A keyword suggestion component 320 may provide for keyword suggestion through interfaces 310, 315 for assisting the revenue generators 110A-N with ad campaign management. The keyword suggestion component 320 may assist the revenue generators 110A-N in searching for available search terms. As described above, in an auction-based system or marketplace, revenue generators 110A-N may bid for search terms or groups of terms, which, when used in a search by the users 120A-N, may result in displaying advertisement listings or links among the search results. The keyword suggestion component 320 may provide suggestions to revenue generators 110A-N regarding terms they may bidding on. For example, the keyword suggestion component 320 may look at actual searches conducted in the last month and provide a suggestion based upon previous searches. Alternatively or in addition the keyword suggestion component 320 may look at the terms other revenue generators 110A-N of similar products or services are bidding on and suggest these terms to the revenue generator A 110A. Alternatively or in addition the keyword suggestion component 320 may determine terms that the users 120A-N who bought similar products or services may use in their searches and suggest these terms to the revenue generator A 110A. The keyword suggestion component 320 may maintain a table of terms divided into several categories of products and services and may allow a revenue generator A 110A to browse through and pick the available terms. Alternatively or in addition, the keyword suggestion component 320 may use other techniques for assisting revenue generators 110A-N in the term selection process, such as suggesting a new term to the revenue generator A 110A if the advertised products and services are unique.

A creative suggestion component 322 may provide for creative suggestion through interfaces 310, 315 for assisting the revenue generators 110A-N with ad campaign management. The creative suggestion component 322 may assist the revenue generators 110A-N in generating a large number and variety of creative variants. The A/B testing feature, discussed further below, may allow a revenue generator A 110A to specify multiple variants of an ad. The creative suggestion component 322 may provide suggestions to revenue generators 110A-N regarding creative variants they may utilize in their advertising campaign. For example, the creative suggestion component 322 may generate permutations of existing creatives and provide a suggestion. Alternatively or in addition the creative suggestion component 322 may look at the creatives of other revenue generators 110A-N of similar products or services are utilizing and suggest variations of these creatives to the revenue generator A 110A. Alternatively or in addition the creative suggestion component 322 may determine creatives that the users 120A-N who bought similar products or services may have clicked through, and suggest variations of these creatives to the revenue generator A 110A. The creative suggestion component 322 may maintain a table of suggested creatives and may allow a revenue generator A 110A to browse through and filter any undesirable suggested creatives. The desirable suggested creatives may be added to the CDS 305 and communicated to the weight optimizer 370. Alternatively or in addition, the creative suggestion component 322 may use other techniques for assisting revenue generators 110A-N in the creative generation process, such as suggesting a creative to the revenue generator A 110A based on information extracted from the site referenced by the destination URL, or any other method of generating relevant creatives.

The editorial processing system (EPS) 325 may ensure relevance and may mitigate risks associated with the listings of the revenue generators 110A-N before a listing may participate in the auction. In general, the EPS 325 may review new or revised ads. The EPS 325 may apply a set of business rules that may determine the accuracy and relevance of the listings of the revenue generator A 110A. These rules may be applied automatically by the EPS 325 or may be applied through a human editorial review. The EPS 325 may, for example, detect inappropriate content in the listings of a revenue generator A 110A or may detect illegally used trademark terms. The EPS 325 may respond with an annotation such as rejected, approved, rejected but suggested changes, etc.

Alternatively or in addition, the EPS 325 may include a quick check component. The quick check component may perform a preliminary or a “quick check” to determine whether to reject ad automatically before it is submitted to a human editor and stored in the campaign data store 305. Either the API 310 or the UI 315 may invoke the quick check component service so that the revenue generator A 110A may receive instant feedback. For example, use of prohibited words, such as “best” in the submitted advertisement, may be quickly detected by the quick check component and, obviating the need for human editorial review. In contrast, using words such as gambling, adult services, etc., the quick check component may determine that the ad may requires more thorough editorial review. One of the benefits of the quick check component may be the rapid provision of feedback to the revenue generator A 110A, which may enable the revenue generator A 110A to revise the listing right away and thus to expedite review by the human editor.

Again with reference to FIG. 3, the pod 300 may further include a channel server 350, which may be operable to receive and process data received from an advertising channel, such as Google.com and MSN.com. This data may include but may not be limited to the customer profiles, historical user behavior information, raw impressions, cost, clicks, etc. Additional description of user information and its uses can be found in U.S. Patent Application No. 60/546,699 and Ser. No. 10/783,383, the entirety of which are both hereby incorporated by reference. The channel server 350 may further be operable to re-format the received data into a format supported by the ad campaign management system and to store the reformatted data into the campaign data store 305.

The pod 300 may further include a business information group (BIG) component 355. The BIG 355 may be operable to receive cost, click, and impression data that is coming into the pod 300 from various sources including the channel server 350, pod collection server 335 and third-party analytics feeds component 380. The BIG 355 may assure that this data is received in a correct and timely manner. The BIG 355 may also perform aggregation and filtering on raw data impressions that may be coming into the pod 300. The BIG 355 may be further operable to store the collected and processed data into the Campaign Data Store 305. Alternatively or in addition the BIG 355 may also perform internal reporting, such as preparing business reports and financial projections, or any other reporting that may be of relevance to a revenue generator A 110A. The BIG 355 may be operable to communicate with the Account Monitoring component 360, which may be described in more detail below.

The pod 300 may further include an account monitoring component 360. This component 360 may be operable to perform budgeting and campaign asset allocation. For example, the account monitoring component 360 may determine how much money is left in an account of the revenue generator A 110A and how much may be spent on a particular ad campaign. The account monitoring component 360 may employ a budgeting functionality to provide efficient campaign asset allocation. For example, the revenue generator A 110A may set an ad campaign budget for a month to $500. The account monitoring component 360 may implement an ad bidding scheme that gets actual spending for that month as close to $500 as possible. One example of a bidding scheme employed by the account monitoring component 360 may be to lower the bids of the revenue generator A 110A to reduce how often the ads of the revenue generator A 110A may be displayed, thereby decreasing how much the revenue generator A 110A may spend per month. The bidding scheme may be performed dynamically. Another example of budgeting by the account monitoring component 360 may be to throttle the rate at which advertisements may be served (e.g., a fraction of the time it is served) without changing the bid of the revenue generator A 110A (whereas in the previous example the bid was changed, not the rate at which advertisements were served). Another example of throttling may be to not serve an ad as often as possible but put it out according to a rotation.

The pod 300 may further include a financial component 365, which may be an accounting application for planning and budgeting ad campaign expenses. Using the financial component 365 the revenue generators 110A-N may specify budgets and allocate campaign assets. The financial component 365 may provide a revenue generator A 110A with the ability to change distribution of campaign budget and to move money between different campaigns. The financial component 365 may also present revenue generators 110A-N with information on how much money is left in the account and how much can be spent on a particular ad campaign. Alternatively or in addition the financial component 365 may further be operable to provide revenue generators 110A-N with information regarding profitability, revenue, and expenses of their ad campaigns. The financial component 365 may, for example, be implemented using one or more financial suites from Oracle Corporation, SAP AG, Peoplesoft Inc., or any other financial software developer.

The pod 300 may further include an online sign-up (OLS) component 395. The OLS component 395 may be operable to provide revenue generators 110A-N with a secure online sign-up environment, in which secure information, such as credit card information, can be exchanged. The secure connection between the device of the revenue generator A 110A and the OLS component 395 may be established, for example, using Secure Hypertext Transfer Protocol (“SHTTP”), Secure Sockets Layer (“SSL”) or any other public-key cryptographic techniques.

The pod 300 may further include a quality score component 385. A quality score may be one of the ad performance parameters that may be used by the search serving components, such as advertising channels and search engines, to qualify the relative quality of the displayed ads. Thus the quality score may be calculated by the search serving components and may be fed into the ad campaign management system through the quality score component 385. Alternatively or in addition, the quality score may be displayed to the revenue generator A 110A, so that the revenue generator A 110A may revise the ad to improve its quality score. For example, if an ad has a high quality score, then the revenue generator A 110A may know not to try to spend money and time trying to perfect the ad. However, if an ad has a low quality score, it may be revised to improve ad's quality score.

The pod 300 may further include a forecasting component 390, which may be an analytical tool for assisting the revenue generator A 110A with keyword selection. The forecasting component may be operable to predict keywords trends, forecast volume of visitor traffic based on the ad's position, as well as estimating bid value for certain ad positions.

The forecasting component 390 may be operable to analyze past performance and to discover search term trends in the historical data. For example, the term “iPod” may have existed several years ago, while now it may be a very common term. Alternatively or in addition the forecasting component 390 may perform macro-trending, which may include forecasting to determine terms that may be popular in a particular region, for example, California, or with particular demographic, such as males. Alternatively or in addition the forecasting component 390 may provide event-related macro- and micro-trending. Such events may include, for example, Mother's Day, Christmas, etc. To perform event-related trending for terms related to, for example, Mother's Day or Christmas, the forecasting component 390 may look at search patterns on flower-related terms or wrapping paper terms. Alternatively or in addition the forecasting component 390 may analyze the historic data to predict the number of impressions or clicks that may be expected for an ad having a particular rank. The forecasting component 390 may be operable to predict a bid value necessary to place the ad in a particular position.

The pod 300 may further include a weight optimizer 370, which may adjust the weights (relative display frequency) for rotating elements as part of alternative ad (“A/B”) functionality that may be provided by the ad campaign management system. The A/B testing feature may allow a revenue generator A 110A to specify multiple variants of an attribute of an ad. These elements may include creative (title, description and display URL), destination (landing URL) and perhaps other elements such as promotions and display prices. More specifically, when an one of the users 120A-N performs a search, the ad campaign management system may assemble one of the possible variants of the relevant ad and may provide it to the advertising channel for display to the users 120A-N. The ad campaign management system may also attach tracking codes associated with the ad, indicating which variant of each attribute of the ad may have been actually served. The behavior of the users 120A-N then may be observed and the tracking codes may be used to provide feedback on the performance of each variant of each attribute of the ad.

In determining the weight for a particular element, the weight optimizer component 370 may look at actual performance of ads to determine optimal ads for delivery. The weight optimizer component 370 may operate in multiple modes. For example, in Optimize mode the weight (frequency of display) of each variant may be changed over time, based on the measured outcomes associated with each variant. Thus, the weight optimizer component 370 may be responsible for changing the weights based on the measured outcomes. The weight optimizer component 370 may also operate according to Static mode, in which the weights (frequency of display) of each variant may not be changed by the system. This mode may provide data pertaining to measured outcomes to the revenue generators 110A-N. The revenue generators 110A-N may have the option to manually change the weights.

The pod 300 may further include a campaign optimizer component 375, which may facilitate ad campaign optimization to meet specific ad campaign strategies, such as increasing number of conversions from displayed ads while minimizing the cost of the campaign. The campaign optimizer component 375 may use data received from the channel server 350, forecasting component 390, third party analytics feed component 390, quality score component 385, and/or BIG 355 to determine how much to bid on which ads, how to allocate the budget across different ads, how to spend money over the entire period of the campaign, etc. Furthermore, campaign optimization may not only focus on executing ads efficiently, but also on performing arbitrage between ads across various channels and tactics to determine where the limited ad campaign budget may be most effective.

The campaign optimizer component 375 may analyze the obtained analytics data, including ad campaign information, ad campaign performance information, as well as potentially other information, such as user information, to facilitate determining, or to determine, an optimal ad campaign strategy. Herein, an “optimal” ad campaign strategy may include any ad campaign strategy that may be determined to be optimal or superior to other strategies, determined to be likely to be optimal, forecasted or anticipated to be optimal or likely to be optimal, etc. Optimizing may be performed with respect to parameters, or a combination of parameters, specified by a revenue generator A 110A, supplied automatically or partially automatically by the ad campaigns facilitation program, or in other ways.

In addition to the foregoing, ad campaign strategy may include any course of action (including, for example, changing or not changing current settings or strategy) or conduct, or aspects or components thereof, relating to an ad campaign. An ad campaign strategy may include a recommendation regarding a course of action regarding one or more aspects or parameters of an ad campaign, and may include an immediate course of action or set of parameters, or a course of action or set of parameters for a specified window of time. For example, an optimal ad campaign strategy in the context of an auction-based search result listings situation, may include recommendations relating to bidding and bid hiding rates in connection with an auction or marketplace relating to search term or group of terms in connection with sponsored listings.

The campaign optimizer component 375 may be operable to analyze ad campaign performance information to determine an optimal ad campaign strategy. Ad campaign performance information may include a variety of information pertaining to historical performance of an ad campaign, channel, tactic, or ad or group of ads. Ad campaign performance information may include many types of information which may indicate or provide a suggestion of how effectively ads, or ads presented though a particular channel, etc., influence or are likely to influence the behavior of the users 120A-N. For example, an advertising channel such as Yahoo! may collect performance information with respect to a particular sponsored search result listing. The information may include a number or percentage of users 120A-N who clicked on the link, or who shopped at or purchased a product at the advertisers Web site as a result of the listing, etc.

The campaign optimizer component 375 may be operable to analyze ad campaign information to determine an optimal ad campaign strategy. Ad campaign information may include campaign objectives or budget-related conditions or constraints, or can include information specifying, defining, or describing ads themselves, channels, tactics, etc. With regard to auction-based sponsored search result listings, ad campaign information may include bidding parameters such as maximum or minimum bids or bidding positions (rankings or prominence of listings) associated with a term or term cluster, for instance, as further described below. Such ad campaign information can also include campaign objectives, quotas or goals expressed, for example in metrics such as ROAS (return on ad spend), CPI (clicks per impression), or in other metrics, and with respect to individual ads, terms or term groups, channels, tactics, etc.

The campaign optimizer component 375 may further include bid optimization functionality, which may be used by the system to determine a desirable or optimal bid for a listing, such as a paid search result. The bid optimization functionality of the campaign optimizer component 375 may be used to constrain the set targets and constraints on the bids set by a revenue generator A 110A. The constraints may include a maximum bid and a minimum bid. The targets may be associated with the listing and can be specified in terms of one or more metrics related to the performance of the listing. The campaign optimizer component 375 may analyze recent past analytics in connection with the metric and specify a bid recommendation forecasted by the bid optimizer functionality to achieve the target or get as close to the target as possible. The campaign optimizer component 375 may also provide a recommendation for a listing, which may include a maximum bid and an update period, which update period may be a time between maximum bid hiding updates.

To facilitate ad campaign management and optimization, the pod 300 may be further operable to collect visitor state data from the websites of the revenue generators 110A-N. The pod 300 may utilize a pod collection server 335, script server 340, and image server 345 to collect visitor state data and to store the same in the campaign data store 305. The collected visitor state data may then be used by various components of the pod 300 including, but not limited to, campaign optimizer component 375, forecasting component 390, and BIG 355 to generate ad campaign performance data.

The various methods of data collection may include, but are not limited to, full analytic, campaign only, conversion counter and sampling. Alternatively or in addition full analytics collection may provide the most robust collection method. The full analytics collection may collect marketing-based and free search-based leads. As a result, the revenue generator A 110A may see a complete picture of how leads and conversions are generated. Primarily, the full analytics collection method may provide a full funnel report that may provide a key view into how visitors of the website of the revenue generator A 110A may go from being a lead through to browser, shopper, and finally a paying customer. Visitor state storage on Campaign Data Store 305 may also allow for repeat and return customer report data and for a full suite of accreditation methods.

Alternatively or in addition a campaign only analytics collection method may be like full analytic but only paid marketing events may be tracked and result events generated from free search may be ignored or discarded. This may have the advantage of providing funnel and repeating visitor reports as well as a reduced data collection and storage rate. The campaign only analytics method may provide a balance of rich report data and reduced collection, processing, and storage cost.

Alternatively or in addition the conversion counter method may be the most simple analytics data collection available. With conversion counter analytics, the revenue generator A 110A may only place a tag on pages where revenue may be generated. The image server 345 may place the lead “stack” in a cookie, which may be used to accredit the proper term/creative to the conversion event. This data collection mechanism may generate enough data to provide optimization on creative weighting. It may be further noted that a direct accreditation method may be applied to the conversion counter method. In the conversion counter approach, no visitor state storage may be needed and only conversion events may be received. Thus, this approach may have a minimal effect on pod 300 load and data storage requirements. Alternatively or in addition a sampling method may be utilized. In accordance with this method, only a random number of unique visitors, for example ten percent, may be tracked, which may reduce data collection and storage.

In order to allow for accreditation of the lead generation source to a conversion event, the state of the customer session on the website of the revenue generator A 110A may be maintained. Accreditation may be the process by which all the marketing events are tied to a specific, or set of specific, marketing activities. There may be two approaches that may be utilized for storage of visitor state: client-side cookies and server-side database.

The cookies may be used as client-side visitor state storage. When cookies are used to store visitor state one of two methods may be used to store visitor state. A redirection server may be used on the lead generating event to add the visitor state to the cookie at the click event. Alternatively or in addition a collection server may set the cookie at the time of a lead event. While visitor state in the cookie approach may be the most cost effective it may have several disadvantages. Generally, cookies may have low storage requirements and thus an active search user (typically, most valuable users because they generate the most revenue) may lose accreditation information as their lead stack grows and causes some older events to be pushed out. As a result, a conversion event may occur where the lead information may have been lost in the stack and thus the accreditation may be lost. Furthermore, cookie-off users may be essentially invisible to the system. Moreover, efficacy may be reduced due to the additional time that may be needed to parse the collection server request when the cookie is set, which may cause the users 120A-N to click away from the lead page before the cookie can be completed. Finally, cookie based visitor state storage may prevent any internal analysis of the behavior of the users 120A-N.

Alternatively or in addition a server-side database, such as the CDS 305, may be used to store visitor state. Using server side storage in a database may offer the high efficacy rates but at the additional cost of the storage. Using server side storage of visitor state may allow the ad campaign management system to have more advanced accreditation models, which may allow for assist-based accreditation. Efficacy rates over cookie based visitor state storage may be increased due to many factors. Primarily the system may no longer be limited in the amount of visitor state storage a single user A 120A may have so no lead loss may occur. Cookies off users may still be traced as unique visitors so they may still be tracked (although at a reduced rate of accuracy) and thus may be able to be included. Collection event processing latency may be greatly reduced because the event may be just logged and then actually processed later. With the cookie approach lead accreditation may occur at the time the event is received because the cookie may be evaluated before the request is returned by the beacon servers. Furthermore, with visitor state stored in the campaign data store 305, valuable marketing data may be collected and analyzed for internal use.

The ad campaign management system may utilize a combination of the above-described client-side cookies and server-side database techniques to collect and maintain visitor state data. In particular, as indicated above the pod 300 may utilize a pod collection server 335, script server 340, and image server 345 to collect visitor state data and to store the same in the campaign data store 305. The pod collection server 335, script server 340 and image server 345 may be implemented, for example, as Java servlets.

FIG. 4 illustrates a data structure for organizing and maintaining revenue generator account information in advertising campaign management system of FIG. 3, or other systems for managing advertisement campaigns. An ad campaign management system may include a data store 400 that may facilitate hierarchical storage of ad campaign data, providing advertisers with multiple levels of structure for control of advertisement content. The one or more pods provided by an ad campaign management system, may include a data store 400, such as the campaign data store 305 in FIG. 3.

The data store 400 may maintain a plurality of user accounts for managing advertisement content associated with one or more advertised Web properties. A revenue generator A 110A utilizing services of the ad campaign management system may be provided with a master account 405 for receiving aggregated analytics relating to the master account 405 and managing or optimizing Web properties 410 and advertisements within the master account 405 based on the aggregated analytics. A Web property 410 may include a website, or a combination of related websites and pages for which the revenue generator A 110A may be advertising. Furthermore, within master account 405, a revenue generator A 110A may create several accounts 420 to separately manage ad campaigns, as well as to collect ad performance information.

To facilitate tracking and collection of ad performance data from Web properties 410, the data store 400 may further maintain custom tags, program code, navigation code, etc. 415. A tag 415 may include a piece of code that may be created by the system and placed on relevant Web pages of a given website to allow automatic tracking and collection of data indicative of customer session on the website of the revenue generator A 110A. For example, a tag 415 may be used to track user A 120A visits, interaction, or purchases from a website to which the user A 120A navigates as a result of clicking on an advertisement link associated with the website. Depending on specific needs and business objective of a given revenue generator A 110A, tags may be coded to collect specific information about the customer session that may be of interest to the revenue generator A 110A. Thus, some tags 415 may enable collection of data on numbers of raw clicks on the website of the revenue generator A 110A website, while others tags 415 may track numbers of clicks that may have resulted in conversions, e.g., purchase of a product or service from the website of the revenue generator A 110A. The data collection may be limited to other portions of the customer session.

Alternatively or in addition features or technologies may be utilized, such as, for example, HTML tagging, data tracking, and related technologies, as described in U.S. patent application Ser. Nos. 09/832,434 and 09/587,236, the entirety of which are both hereby incorporated herein by reference.

Alternatively or in addition within a master account 405, a revenue generator A 110A may maintain one or more accounts 420, which may be used to receive analytics related to a specific account 420 and manage ad campaign spending associated with individual Web properties 410. Thus, accounts 420 may allow the revenue generators 110A-N to distribute their advertising funding between different Web properties 410 and between separate ad campaigns 425. A given ad campaign 425 may include a set of one or more advertising activities or conduct directed to accomplishing a common advertising goal, such as the marketing or sales of a particular product, service, or content, or group of products, services or content. Two ad campaigns may be considered disparate when the ad campaigns are directed to different advertising goals. For example, a revenue generator A 110A may wish to advertise a product for sale and a service associated with this product. Thus, the revenue generator A 110A may store separate ad campaigns 425 for advertising the product and the service.

Storage of an ad campaign 425 may be further subdivided into several ad groups 430. An ad Group 430 may be thought of as a conceptual compartment or container that includes ads and ad parameters for ads that may be handled in a similar manner. An ad group 430 may allow for micro-targeting, e.g., grouping ads targeted to a given audience, a demographic group, or a family of products. For example, an ad group may be related to a given manufacturer's products, such as Sony, Microsoft, etc. or a family of high-end electronics, such as TVs, DVDs, etc. There may be a number of ways in which a given group of ads may be managed in a similar manner. For example, a revenue generator A 110A may specify that there be a certain markup (e.g., 50%) on items in a given ad group, may want to distribute all those ads in a certain way, or may want to spend a certain amount of its budget on those advertisements. Further, an ad group 430 provides a convenient tool for a revenue generator A 110A to move a large group of ads and ad parameters from one ad campaign 425 to another ad campaign 425, or to clone a large group of ads and ad parameters from one ad campaign 425 to another ad campaign 425

Changes made to the parameters of a given ad group 430 may apply to all ads within the given ad group 430. For example, one such parameter may be pricing. For a sponsored search, a revenue generator A 110A may set the default price for the whole ad group 430 but may override the price on each individual term. Similarly, a revenue generator A 110A may further specify that certain terms are low value, but decide to increase the amount spent on another term uniformly across all ads in a given ad group 430. Thus, storage according to one or more ad groups 430 may enable revenue generators 110A-N to bridge the gap between ad campaigns and the individual ads including a given ad campaign.

A given ad may contain one or more items of advertising content that may be used to create ads/terms in an ad group, including, but not limited to, creatives (e.g., titles, descriptions) and destination URLs (plus associated URL tracking codes). Optionally, a given ad may contain a {KEYWORD} token for substitution in the title, description, or other ad component. Furthermore, ads may exist as a template in an ad library (not pictured) that can be reused across ad groups or a local ad that is used and stored only within a specific ad group. The ad library, which may be provided by the ad campaign management system, may allow revenue generators 110A-N to store ad templates, sharing and reusing them across campaigns and ad groups 430. Ads in the ad library may be shared within an account, e.g., each account may have its own library.

An ad group 430 may utilize numerous tactics for achieving advertising goals. The term “tactic” may include a particular form or type of advertising. For example, in on-line advertising, tactics may include sponsored search result listings 435, banner advertisements 455, content match 470, etc. In off-line advertising, tactics may include television commercials, radio commercials, newspaper advertisements, etc. Alternatively or in addition tactics may include subsets or supersets of the listed examples or other examples. For instance, on-line advertising may be an example of a broader tactic than the narrower tactic of sponsored search result listings. Furthermore, the revenue generator A 110A may utilize multiple advertising channels for different tactics. For example, the revenue generator A 110A may utilize sponsored search listings in several websites or portals, such as Yahoo!, Google.com, MSN.com, etc. A revenue generator A 110A may set parameters within the ad group 430 to place a spend limit for each type of advertising tactic including the ad group 430.

One example of an advertising tactic may be sponsored search 435. Sponsored search 435 may operate as follows: an auction-based system or marketplace may be used by the revenue generators 110A-N to bid for search terms or groups of terms, which, when used in a search, may cause the display of the ad listings or links of the revenue generator A 110A among the display results. Revenue generators 110A-N may further bid for position or prominence of their listings in the search results. With regard to auction-based sponsored search 435, a revenue generator A 110A may provide a uniform resource locator (URL) 440 to the webpage to which the ad may take the user A 120A if clicked on, as well as the text of the advertisement 445 that may be displayed. The revenue generator A 110A may further identify one or more terms 450 that may be associated with the advertisement 445.

Another example of advertising tactic may be content match 470. Storage of content match advertisements 480 may be used by the revenue generator A 110A to complement, or as alternative to, the sponsored search tactic 435. Ads stored according to the content match tactic 470 may be displayed alongside relevant articles, product reviews, etc, presented to the customers. For the content match tactic 470, the data store 400 may store one or more URLs 475 identifying the address of a webpage where a given ad may take the user A 120A if clicked on, as well as the text, image, video or other type of multimedia including the creative portion of the advertisement 480.

Another example of an advertising tactic may be a banner ad 455. A banner ad tactic 455 may be used by the revenue generator A 110A to complement, or as an alternative to, the sponsored search tactic 435 and content match tactic 470. In contrast to the sponsored search tactic and content match tactic, which are usually based on a pay-per-click payment scheme, a revenue generator A 110A may pay for every display of the banner ad 465, referred to as an impression. Alternatively, if the banner ad displays a phone number, the revenue generator A 110A may only be billed when a user calls the phone number associated with the advertisement. Thus, for the banner ad tactic, the data store 400 may maintain a URL 460 to the webpage where the ad may take the user A 120A if clicked on, as well as the creative that may include the banner ad 465.

The data store 400 of the ad campaign management system may further store various parameters for each ad group 430. Such parameters may include, for example, maximum or minimum bids or bidding positions (rankings or prominence of listings) associated with a term or term cluster for the particular ad group or ads within a given ad group 430. As described above, in an auction-based sponsored search result listings environment, prominence or rank of listings may be closely related to ad performance, and therefore may be a useful parameter in ad campaign management. The rank of a given ad may determine the quality of the placement of the ad on pages that may be displayed to the users 120A-N. Although details vary by advertising channel, top-ranked listings may typically appear at the top of a page, the next listings may appear in the right rail and additional listings may appear at the bottom of the page. Listings ranked below the top five or so may appear on subsequent search results pages.

There is a correlation between rank and both number of impressions and click-through rate (clicks per impression), which may provide an opportunity for revenue generators 110A-N to pay more per click (get a higher rank) in order to get more users 120A-N to their web site. The result may be that a revenue generator A 110A may determine, how much the revenue generator A 110A may be willing to bid for each listing based on the business objectives of the revenue generator A 110A and the quality of the traffic on their web site that may be generated by the listing. This information may also be stored for a given ad group 430 in the data store 400 of the ad campaign management system.

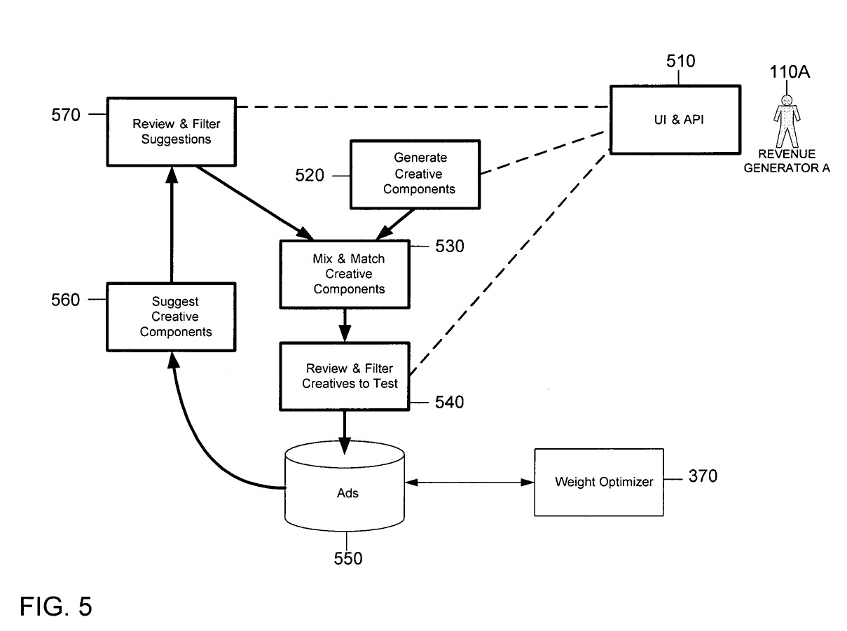

FIG. 5 is block diagram of the process flow of the system of FIG. 1, or other systems for generating advertising creatives. At block 510, a revenue generator, such as the revenue generator A 110A may interact with the service provider server 240, through a user interface, such as the web application 210A, or through an application programming interface (API), such as through the standalone application 210B. The revenue generator A 110A may interact with the service provider server 240 to generate new online advertisements, or creatives, within an ad group.

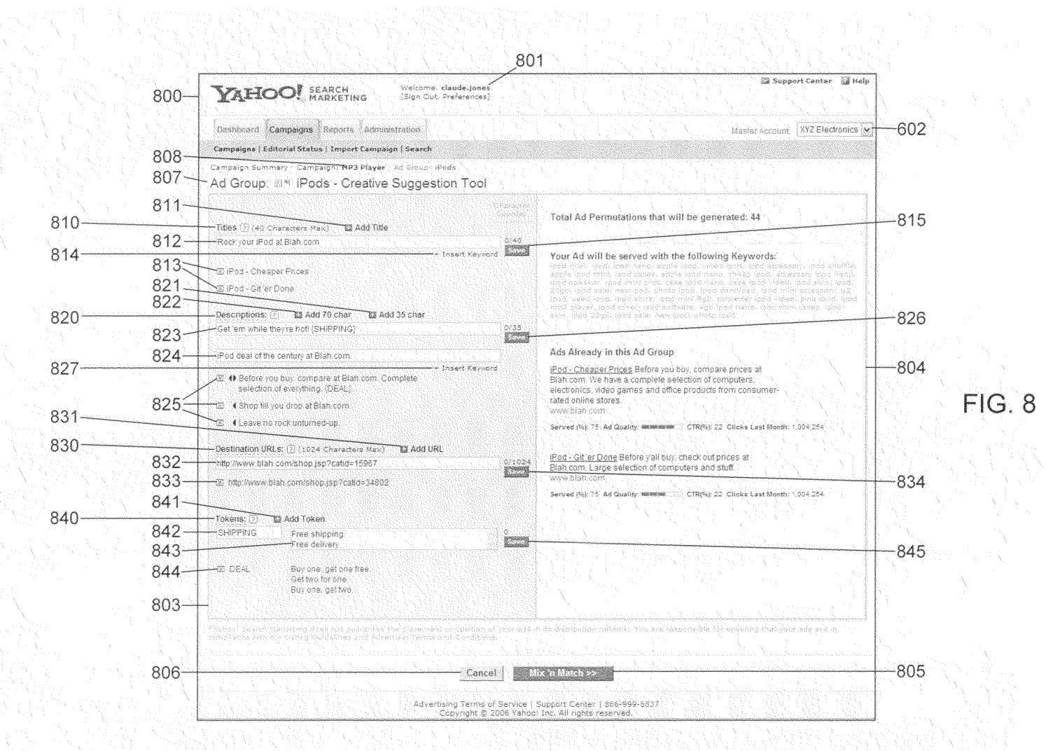

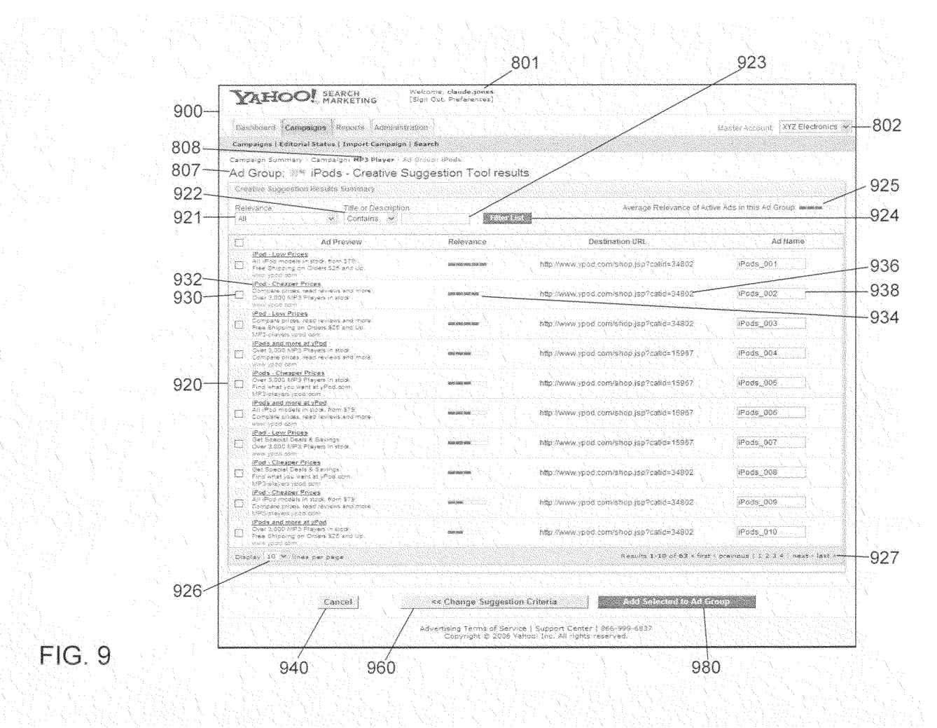

At block 520 the revenue generator A 110A may generate creative components, which may be components of an advertisement. The service provider 130 may supply the revenue generators 110A-N with a tool to assist in generating creative components, such as the creative suggestion tool depicted in the screenshots of FIG. 8 and FIG. 9. There may be several types of creative components, including advertisement titles, advertisement descriptions, which may be split into two half descriptions, destination URLs of the advertisement, and any other components or data that may be effective in an advertisement.

The service provider server 240 may also generate creative components. The service provider server 240 may generate creative components by utilizing data previously submitted by the revenue generator A 110A. The data may include the keywords bid on, titles of advertisements in the ad group 430, descriptions and half descriptions of any advertisement in the ad group 430, the destination URL of any advertisement in the ad group 430, the content of any page referenced by a destination URL in the ad group 430, the creative components of any other advertisements bidding on the same or similar search keywords, or generally any data that may be used in an online advertisement. Alternatively or in addition, the service provider server 240 may conduct a survey of the revenue generators 110A-N. The survey may include questions that may be indicative of which creative components may benefit the revenue generators 110A-N. The service provider server 240 may use the results of the survey to generate creative components.

The service provider server 240 may process the creative components to place them in a displayable form, such as by modifying the word order, punctuation, or capitalization, inserting the component into one or more templates, or generally any processing that may render the creative components displayable.

At block 530, the service provider server 240, may mix and match, or combine, the creative components to generate additional creatives. The additional creatives may be distinct permutations of the different types creative components. Each creative component of one type of creative component may be matched with each of the creative components from the other types. For example, each title may be matched with each description and each destination URL. In the case of half descriptions, each half description may be matched with every other half description to generate several full descriptions. The full descriptions may then be matched with the titles and destination URLs.

The service provider server 240 may rank the generated creatives according to a relevance score, indicating how relevant the advertisements may be to the search terms bid on for the ad group. The relevance score may be calculated by the quality score component 385 in FIG. 3. The relevance score may be a measure of how closely the advertisement may relate to the keywords bid on. The more relevant the advertisement may be the more likely that one of the users 120A-N may click on the advertisement. The relevance score may be calculated by performing content matching on the destination URL and comparing with the keywords bid on, or may simply be determined by comparing the content of the advertisement itself. The relevance score may be determined by any search marketing tool, such as YAHOO! SEARCH MARKETING, or may be determined by a simple relevance algorithm, such as relevance equals the number of keywords located within the text of the advertisement. Alternatively or in addition, the quick check component of the EPS 325 of FIG. 3 may perform an editorial quick check on the additional creatives. The editorial quick check may give the revenue generator A 110A, and/or the system, an indication of whether the advertisement may pass all or some of the editorial requirements.

At block 540, the additional creatives may be displayed to the revenue generator A 110A for review. The revenue generator A 110A may filter out advertisements that may be undesirable. The service provider server 240 may store the creatives selected by the revenue generator A 110A in the advertisement database 550. The weight optimizer 370 may then determine which advertisements from the advertisement database 550 to the users 120A-N when the users 120A-N search for the keywords bid on. The weight optimizer 370 may cycle through displaying each of the advertisements in the ad group to the users 120A-N. The weight optimizer 370 may use metrics, such as click through rates, to determine which advertisements in the ad group are more likely to be clicked on by the users 120A-N. The weight optimizer 370 may display the advertisements in the ad group with higher click through rates more often than advertisements with low click through rates.

At block 560 the service provider server 240 may retrieve advertisements from the advertisement database 550 to determine whether any additional creative components that may be generated. The service provider server 240 may process any additional creative components. At block 570 if any additional creative components are generated, the service provider server 240 may notify the revenue generator A 110A that there are further creative components for review. The service provider server 240 may notify the revenue generator A 110A by using an alert or by any other means of notification. The alert may appear to the revenue generator A 110A the next time the revenue generator A 110A interacts with the service provider server 240. After being notified of the additional creative components, the revenue generator A 110A may review the creative components and filter out any undesirable components. The system 100 may then return to block 530.

The service provider server 240 may generate creative components that require additional processing time, such as by content matching with the destination URLs. In this case, the service provider 240 may generate any additional creative components, or advertisements, and then notify the revenue generator A 110A of the newly created components and/or advertisements. The service provider server 240 may continually attempt to generate creative components and/or advertisements based on the aforementioned criteria.

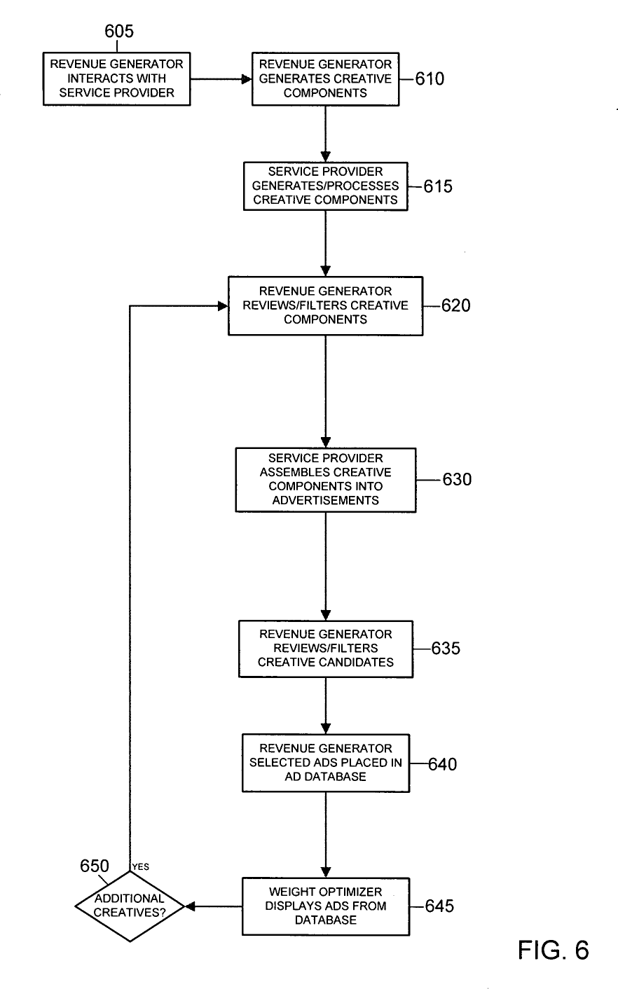

FIG. 6 is a flow chart illustrating the operations of the system of FIG. 1, or other systems for generating advertising creatives. At block 605 a revenue generator, such as the revenue generator A 110A, may interact with the service provider 130, such as by logging on to the service provider server 240. At block 610 the revenue generator A 110A may generate creative components such as through the creative suggestion component 322. At block 615 the service provider server 240 may generate creative components, such as by retrieving data from any advertisements within the ad group, any sites referenced by the destination URLs in the ad group, any titles within the ad group, any descriptions or half descriptions within the ad group, or generally any data that may be useful in an advertisement. The service provider server 240 may then process any generated creative components to ensure the components are fit for display to the users 120A-N. The processing may include modifying the grammar, spelling, punctuation, word order, plurality, or capitalization of the components, inserting the components into one or more templates, or generally any process that may put the components into a displayable form.

At block 620 the generated components may be displayed to the revenue generator A 110A for review. The generated components may be displayed to the revenue generator A 110A in real time, or, for more time intensive processes, the service provider 130 may notify the revenue generator A 110A of the generated components, such as via an alert. The revenue generator A 110A may review the creative components and filter out components that may be undesirable.

At block 630, the service provider server 240 may use the remaining creative components to assemble creatives. The service provider server 240 may combine the creative components to generate a creative for each permutation of components. The service provider 240 may rank the generated creatives according to a relevance score, indicating how relevant the advertisements may be to the search terms bid on for the ad group. The relevance score may be calculated by the quality score component 385 in FIG. 3. The relevance score may be a measure of how closely the advertisement may relate to the keywords bid on for the ad group. The more relevant the advertisement may be the more likely that one of the users 120A-N may click on the advertisement. Alternatively or in addition, the quick check component of the EPS 325 of FIG. 3 may perform an editorial quick check on the additional creatives. The editorial quick check may give the revenue generator A 110A, and/or the system, an indication of whether the advertisement may pass all or some of the editorial requirements.

At block 635 the service provider server 240 may display the generated advertisements to the revenue generator A 110A. The revenue generator A 110A may then review the advertisements and may filter out any advertisements that may be undesirable.

At block 640, the advertisements selected by the revenue generator A 110A may be placed into the advertisement database 550 by the service provider server 240. At block 645 the weight optimizer 370 may display the different advertisements to the users 110A-N. The weight optimizer 370 may utilize metrics relating to the effectiveness of each of the advertisements and may display more effective advertisements more often than less effective advertisements.

At block 650, the service provider server 240 may continue to generate additional advertising creatives. The additional creatives may be based on changes in the campaign of the revenue generator A 110A or based on changes to the sites referenced by the destination URLs. For example, if a site referenced by a destination URL in the ad group 430 included content referencing a promotion, the service provider server 240 may generate an additional creative component with data referring to the promotion. If the service provider server 240 generates any additional creatives the service provider server 240 may notify the revenue generator A 110A and the system 100 may return to block 620.

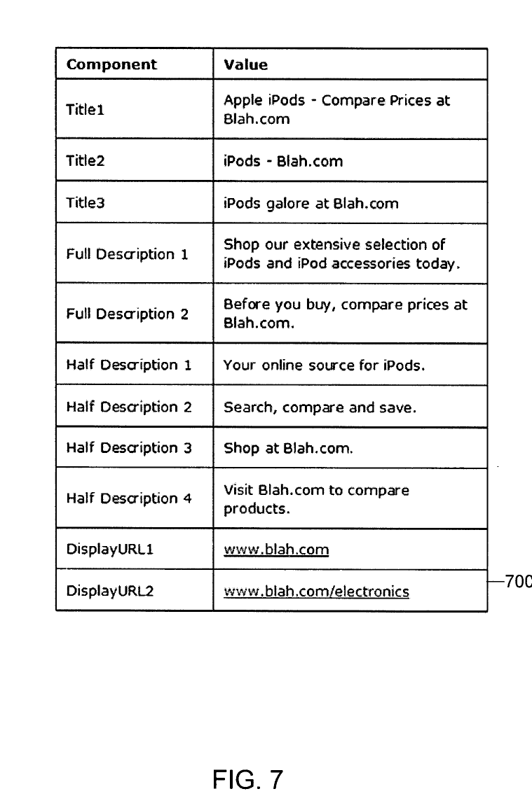

FIG. 7 is a table 700 including data pertaining to creative components in the system of FIG. 1, or other systems for generating advertising creatives. The table 700 includes two columns, a component column and a value column. The component column may indicate the type of the creative component, such as the title, full description, half description, and display URL, or destination URL. For example, if the data in the creative component was retrieved from the title of an advertisement, the component source may be named “Title.” The value column may contain the actual data of the creative component.

The table may demonstrate values various creative components that may be generated by the revenue generator A 110A or by the service provider 130. The service provider may generate advertisements using the data from the value columns. The advertisement may include a title, a full description, or two half descriptions, and a destination URL. Thus, using the data from the table, three titles, fourteen descriptions (two long descriptions and twelve combinations of pairs of half descriptions), and two destination URLs, the service provider 130 may generate a total of eighty four advertisements. Alternatively or in addition, the service provider 130 may not be limited to one title, one description (or two half descriptions) and one destination URL. The service provider 130 may generate advertisements including any permutation of data from the value column.

FIG. 8 is a screenshot of a revenue generator's creative suggestion tool screen in the system of FIG. 1, or other systems for generating advertising creatives. The creative suggestion tool may be implemented by the creative suggestion component 322 of FIG. 3. The revenue generators 110A-N may access the creative suggestion tool through the API 310 or UI 315 of FIG. 3. The screenshot 800 may include a revenue generator identifier 801, a account drop down box 802, an input frame 803, a display frame 804, a mix ′n match button 805, a cancel button, 806, an ad group identifier 807, and a campaign identifier 808.

The input frame 803 may include a title section 810, a description section 820, a destination URL section 830, and a token section 840. The title section 810 may include an add title button 811, a title input box 812, a delete title button 813, an insert keyword button 814, and a save title button 815. The description section 820 may include an add 35 char button 821, an add 70 char button 822, a first description input box 823, a second description input box 824, an insert keyword button 827, delete description buttons 825, and a save description button 826. The destination URL section 830 may include an add URL button 831, an URL input box 832, a delete URL button 833 and a save URL button 834. The token section 840, may include an add token button 841, a token name input box 842, a token value input box 843, a delete token button 844 and a save token button 845.

In operation the revenue generator identified by the revenue generator identifier 801, such as the revenue generator A 110A, may use the creative suggestion tool to add creative components to the ad group 430 identified by the ad group identifier 807. The ad group 430 may belong to the campaign 425 identified by the campaign identifier 808. The campaign 425 may belong to the account 420 identified by the account drop down box 802. The revenue generator A 110A may use the account drop down box 802 to change the account 420. In the screenshot 800, the revenue generator A 110A may be “claude.jones,” the account may be “XYZ Electronics,” the campaign may be “MP3 Player,” and the ad group 430 may be “iPods.” In this case, claude.jones may use the creative suggestion tool to create additional creative components relating to the iPod ad group within the MP3 Player campaign and a part of the XYZ Electronics account.

The display frame 804 may display information relating to other advertisements within the ad group 430 and the keywords associated with advertisements in the ad group 430. The advertisements may be displayed with in their entirety and may be accompanied by data relating to their effectiveness, such as the percentage of times the advertisement was served when the keyword was searched for, an ad quality rating related to the relevance of the advertisement, a click through percentage, a number of clicks in the last month, and generally any metric that may assist in determining the effectiveness of the advertisement. The ad quality rating may be generated by the quality score component 385 in FIG. 3. The display frame 804 may also display the number of advertisement permutations that may be created with the current creative components.

The revenue generator A 110A may click on the add title button 811 to add title creative components. The revenue generator A 110A may enter the title in the title input box 812. The title may be limited to a certain number of characters, such as forty. The revenue generator A 110A may insert one or more keywords bid on into the title by clicking on the insert keyword button 814. The revenue generator A 110A may view existing titles for the ad group below the title input box 812. The existing titles may be deleted by clicking on the delete title buttons 813. The revenue generator A 110A may save the title by clicking on the save title button 815.

The revenue generator A 110A may click on the add 70 char button 822 or the add 35 char button 821, to add a description. The revenue generator A 110A may enter values for the description in the first description input box 823 and/or the second description input box 824. If the revenue generator A 110A is only entering a half description, the revenue generator A 110A may only use the first description box 823. The revenue generator A 110A may add a keyword to the description by clicking on the insert keyword button 827. The existing descriptions and half descriptions may be displayed to the revenue generator A 110A below the second description input box 824. The revenue generator A 110A may delete the existing descriptions and half descriptions by clicking on the delete description buttons 825. The revenue generator A 110A may save the values entered into the first description box 823 and/or the second description box 824, by clicking on the save description button 826.

The revenue generator A 110A may click on the add URL button 831 to add a URL. The revenue generator A 110A may enter the value of the URL in the destination URL input box 832. Existing destination URLs may be displayed below the destination URL input box 832. The existing destination URLs may be deleted by clicking on the delete destination URL button 833. Data entered into the destination URL input box 832 may be saved by clicking on the save destination URL button 834.

The revenue generator A 110A may click on the add token button 841 to add a token. A token may be a set of characters, such as zero or more characters, that represent a larger set of characters, such as zero or more characters. If a token is inserted into the title input box 812, the description input box 832 or the destination URL input box 832, the token may be replaced with the larger set of characters represented by the token. The revenue generator A 110A may enter the name of the token in the token name input box 842. The revenue generator A 110A may enter the value of the token in the token value input box 843. The revenue generator A 110A may save the token by clicking on the save token button 845. The revenue generator A 110A may then enter the name of the token in the title input box 812, first description input box 823, second description input box 824, and/or destination URL input box 832. The token may need to be enclosed in brackets, or some other enclosure, when placed in the title input box 812, first description input box 823, second description input box 824, and/or destination URL input box 832. The service provider server 240 may automatically substitute the name of the token with the value of the token stored in the token value input box 843.

The existing tokens may be displayed below the token name input box 842. The revenue generator A 110A may delete existing tokens by clicking on the delete token button 844. Once the revenue generator A 110A finishes adding creative components, the revenue generator A 110A may click on the mix 'n match button 805. When the revenue generator A 110A clicks on the mix 'n match button 805 the service provider server 240 may generate additional advertisements based on the creative components. If the revenue generator A 110A does not wish to generate additional advertisements, the revenue generator A 110A may click on the cancel button 806.

FIG. 9 is a screenshot of a revenue generator's creative suggestion tool results screen in the system of FIG. 1, or other systems for generating advertising creatives. The creative suggestion tool may be implemented by the creative suggestion component 322 of FIG. 3. The revenue generators 110A-N may access the creative suggestion tool through the API 310 or UI 315 of FIG. 3. The screenshot 900 may include a revenue generator identifier 901, an account drop down box 902, an ad group identifier 807, a campaign identifier 808, a results table 920, a cancel button 940, a change suggestion criteria button 960 and an add selected to ad group button 980. The results table 920 may include a relevance drop down box 921, a title condition drop down box 922, a title input box 923, a filter list button 924, an average relevance indicator 925, a number of lines drop down box 926, navigation buttons 927, and several rows of advertising data. Each row of advertising data may include a select checkbox 930, an ad preview 932, a relevance score 934, a destination URL 936 and an ad name input box 938.

In operation the revenue generator identified by the revenue generator identifier 901, such as the revenue generator A 110A, may use the creative suggestion tool results page to select the generated advertisements to include in the ad group 430 identified by the ad group identifier 807. The ad group 430 may belong to the campaign 425 identified by the campaign identifier 808. The campaign 425 may belong to the account 420 identified by the account drop down box 802. The revenue generator A 110A may use the account drop down box 802 to change the account. In the screenshot 900, the revenue generator A 110A may be “claudejones,” the account 420 may be “XYZ Electronics,” the campaign 425 may be “MP3 Player,” and the ad group 430 may be “iPods.” In this case, claude.jones may use the creative suggestion tool results screen to select the generated creative components add to the iPod ad group within the MP3 Player campaign and a part of the XYZ Electronics account.

The revenue generator A 110A may use the relevance drop down box 921, condition drop down box 922 and title input box 923 to filter the advertisements displayed in the results table 920. The revenue generator A 110A may use the relevance drop down box 921 to specify the level of relevance of advertisements to display. The revenue generator A 110A may use the condition drop down box 922 to specify a condition relating to the text entered in the title input box 923, such as “contains,” “does not contain,” or generally any condition that's capable of filtering advertisement titles. The revenue generator A 110A may enter text in the title input box 923 to filter the advertisements displayed in the results table 920 based on the advertisement title and the condition specified in the condition drop down box 922. The revenue generator A 110A may activate the filter by clicking on the filter list button 924. For example, if the condition drop down box 922 had the value “contains” and the value “mp3 player” was entered in the title input box 923, then only advertisements with a title containing “mp3 player” may be displayed to the revenue generator A 110A in the results table 920. The average relevance indicator 925 may represent the average relevance of the advertisements in the ad group 430 identified by the, ad group identifier 807. The relevance may be determined by the quality score component 385 in FIG. 3.

The revenue generator A 110A may view the ad preview 932, the relevance score 934 and the destination URL 936 and determine whether the advertisement should be added to the ad group 430. If the revenue generator A 110A wishes to add the advertisement to the ad group 430, the revenue generator A 110A may check the select checkbox 930 for the given advertisement. The revenue generator A 110A may view and change the name of the advertisement in the ad name input box 938. The revenue generator A 110A may navigate through the generated advertisements by using the navigation buttons 927. The revenue generator A 110A may user the number of rows drop down box 926 to change the number of lines of the results table 920 displayed per page.

If the revenue generator A 110A has selected generated advertisements to be added to the ad group, the revenue generator A 110A may click on the add to selected ad group button 980. Upon clicking the add selected to ad group button 980, the advertisements with checked select checkboxes 930 may be added to the ad group 430 identified by the ad group identifier 807. If the revenue generator A 110A wishes to change the creative components, the revenue generator A 110A may click on the change suggestion criteria button 960. If the revenue generator A 110A wishes to cancel changes the revenue generator A 110A may click on the cancel button 940.

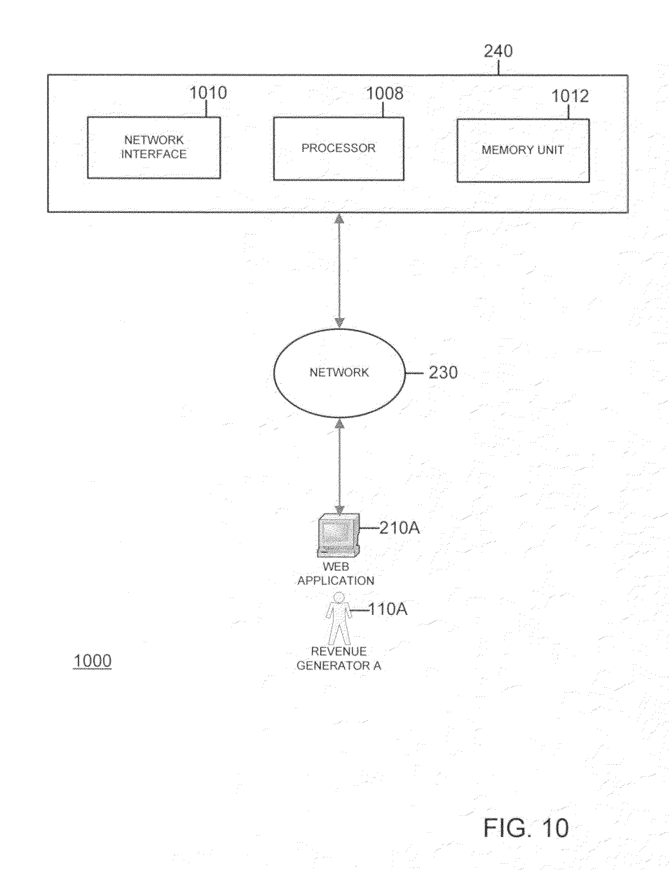

FIG. 10 is a block diagram of a system 1000 implementing the system of FIG. 1, or other systems for generating advertising creatives, for facilitating display and management of advertisement campaign information. The system 1000 may include a service provider 130 (advertisement campaign management system) including one or more service provider servers 240 or advertising services servers 260 in communications with a revenue generator device 210A over a network 230. The service provider server 240 may organize advertisement campaign information into an account hierarchy, as described above, according to a user account 420, one or more ad campaigns 425 associated with the user account 420, one or more ad groups 430 associated with the ad campaigns 425 and keyword and advertisement information associated with the ad groups 430. After organizing the advertisement campaign information, the service provider server 240 may send at least a portion of the advertisement campaign information to the user 220A for display based at least in part on the one or more ad groups 430.

Each server of the service provider servers 240 may include a processor 1408, a network interface 1010 in communication with the processor 1408, and a memory unit 1012 in communication with the processor 1408. The memory unit 1012 may store advertisement campaign information. Advertisement campaign information may include information relating to relationships between a user account 420, ad campaigns 425, and ad groups 430; performance parameters associated with a user account 420, ad campaigns 425, and ad groups 430; or advertisements and keywords associated with a user account 420, ad campaigns 425, and ad groups 430.

The processor 1408 may be operative to perform one or more operations to organize the advertisement campaign information stored in the memory unit 1012 into one or more ad groups 430 as defined by a revenue generator, such as the revenue generator A 110A. As described above, an ad group 430 may be thought of as a conceptual compartment or container that may include advertisements and parameters for advertisements that are handled in a similar manner.

After organizing the advertisement campaign information into one or more ad groups 430, the service provider server 240 may send at least a portion of the advertisement campaign information to the user device 210A via the network interface 1010 for display based at least in part on the one or more ad groups 430. The service provider server 240 may send one or more hypertext pages that may include a graphical user interface (“UI”), such as those in FIGS. 8-9 when the one or more hypertext pages are executed in a web application 210A, stand-alone application 210B, a mobile application 210N, or any other device capable of displaying hypertext pages.

The UI may be operative to allow the revenue generator A 110A to modify advertisement campaign information based at least in part on at least one of the one or more ad groups 430. For example, the revenue generator A 110A may modify a maximum CPC associated with an ad group 430; add or delete a keyword associated with an ad group 430; add or delete advertisements associated with an ad group 430; modify a business objective associated with an ad group 430; modify a search tactic associated with an ad group 430; modify budget constraints associated with an ad group 430; or modify any other performance parameter associated with an ad group 430.

The revenue generator device 210A may send at a least a portion of the advertisement campaign information, organized into one or more ad groups 430, over the network 230, via an application program interface (“API”), such as the API 310 in FIG. 3, of the network interface 1010, to the revenue generator device 210A. The revenue generator device 210A, using an application operative to communicate with the API 310 of the service provider server 240, may receive the advertisement campaign information and may be operative to modify advertisement campaign information based at least in part on at least one of the one or more ad groups 430 as described above.

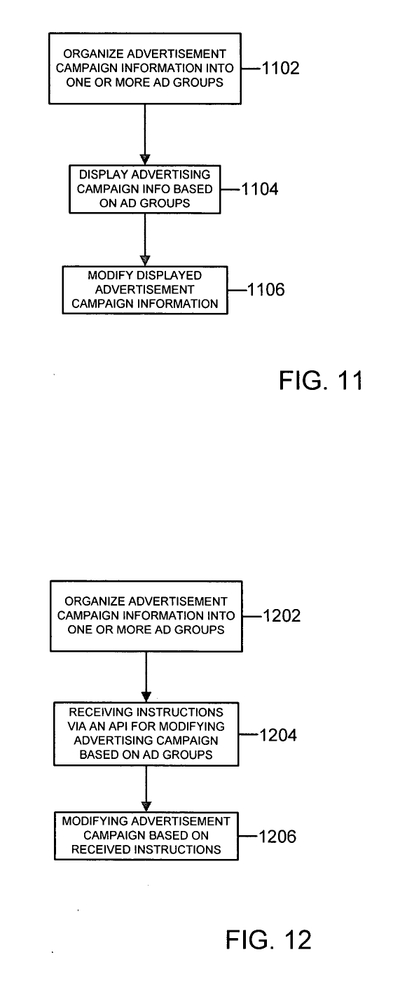

FIG. 11 is a flow diagram of a method for managing advertisement campaign information. The method may begin at block 1102 with the service provider server 240 organizing advertisement campaign information into one or more ad groups 430. At block 1104, at least a portion of the advertisement campaign information may be displayed, such as in FIGS. 8-9, based at least in part on at least one of the one or more ad groups 430. At block 1106 at least a portion of the displayed advertisement campaign information may be modified by the revenue generator A 110A.

The revenue generator A 110A may modify the advertisement campaign information based at least in part on at least one of the one or more ad groups 430. For example, the revenue generator A 110A may modify a maximum CPC associated with an ad group 430; add or delete a keyword associated with an ad group 430; add or delete advertisements associated with an ad group 430; modify a business objective associated with an ad group 430; modify a search tactic associated with an ad group 430; modify budget constraints associated with an ad group 430; or modify any other performance parameter associated with an ad group 430.

FIG. 12 is a flow chart of another method for managing advertisement campaign information. The method may begin at block 1202 with the service provider server 240 organizing advertisement campaign information into one or more ad groups 430. At block 1204, instructions may be received via an application program interface (“API”), such as the API 310 in FIG. 3, for modifying at least a portion of the advertisement campaign information based at least in part on at least one of the one or more ad groups 430. At block 1206 at least a portion of the advertisement campaign information may be modified based on the received instructions.

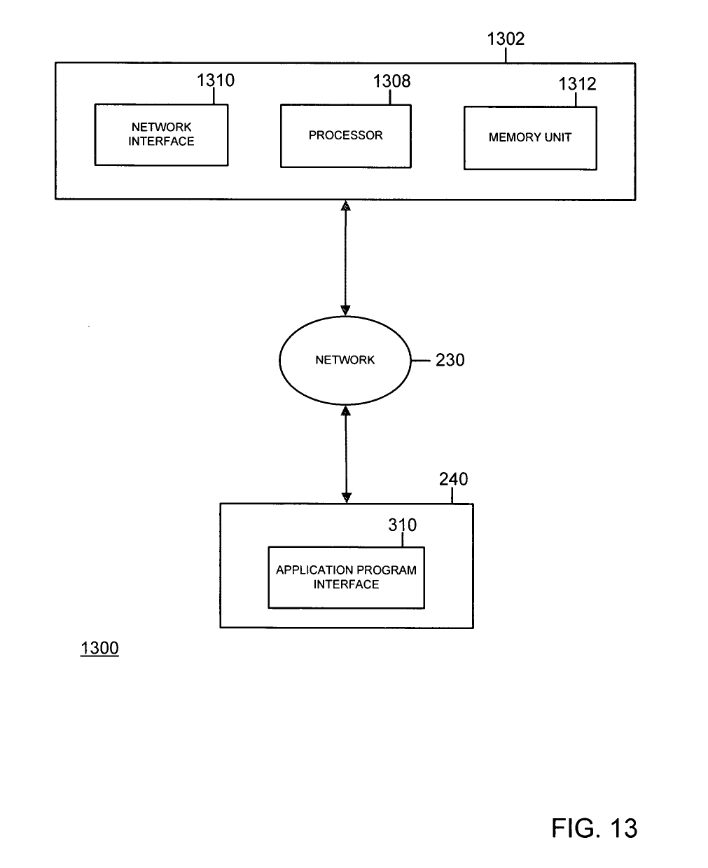

FIG. 13 is a block diagram of a system 1302 for interacting with an application program interface (“API”) 310 of the service provider server 240 implementing the system of FIG. 1, or other systems for generating advertising creatives over a network 230. The system 1302 may include a processor 1308, a network interface 1310 in communication with the processor 1308, and a memory unit 1312 in communication with the processor 1308.

The processor 1308 may be operative to execute one or more instructions stored in the memory unit 1312 to communicate via the network interface 1310 with the API 310 of the service provider server 240. The processor 1308 may execute instructions to communicate with the API 310 to send commands defining how to organize advertisement campaign information into one or more ad groups 430. The processor 1308 may execute instructions to communicate with the API 310 to send instructions to the service provider server 240 to modify advertisement campaign information organized into one or more ad groups 430 based at least in part on at least one of the one or more ad groups 430. The processor 1308 may execute instructions to communicate with the API 310 to receive forecasting information related to advertisement campaign information organized into one or more ad groups 430 and send instructions to the service provider server 240 to modify at least one ad group 430 based on the forecasting information to optimize performance of one or more ad groups 430. The processor 1308 may execute instructions to communicate with the API 310 to send information to the service provider server 240 regarding customization of a report including advertisement campaign information organized into one or more ad groups 430 and receive the customized report via the API 310 of the service provider server 240.

FIG. 14 illustrates a general computer system 1400, which may represent a service provider server 240, a third party server 250, an advertising services server 260 or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 1400 may include a set of instructions 1424 that may be executed to cause the computer system 1400 to perform any one or more of the methods or computer based functions disclosed herein. The computer system 1400 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1400 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1424 (sequential or otherwise) that specify actions to be taken by that machine. The computer system 1400 may be implemented using electronic devices that provide voice, video or data communication. Further, while a single computer system 1400 may be illustrated, the term “system” shall also be taken to include any collection of systems or sub-systems that individually or jointly execute a set, or multiple sets, of instructions to perform one or more computer functions.

As illustrated in FIG. 14, the computer system 1400 may include a processor 1402, such as, a central processing unit (CPU), a graphics processing unit (GPU), or both. The processor 1402 may be a component in a variety of systems. For example, the processor 1402 may be part of a standard personal computer or a workstation. The processor 1402 may be one or more general processors, digital signal processors, application specific integrated circuits, field programmable gate arrays, servers, networks, digital circuits, analog circuits, combinations thereof, or other now known or later developed devices for analyzing and processing data. The processor 1402 may implement a software program, such as code generated manually (i.e., programmed).

The computer system 1400 may include a memory 1404 that can communicate via a bus 1408. The memory 1404 may be a main memory, a static memory, or a dynamic memory. The memory 1404 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1404 may include a cache or random access memory for the processor 1402. Alternatively or in addition, the memory 1404 may be separate from the processor 1402, such as a cache memory of a processor, the system memory, or other memory. The memory 1404 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1404 may be operable to store instructions 1424 executable by the processor 1402. The functions, acts or tasks illustrated in the figures or described herein may be performed by the programmed processor 1402 executing the instructions 1424 stored in the memory 1404. The functions, acts or tasks may be independent of the particular type of instructions set, storage media, processor or processing strategy and may be performed by software, hardware, integrated circuits, firm-based micro-code and the like, operating alone or in combination. Likewise, processing strategies may include multiprocessing, multitasking, parallel processing and the like.

The computer system 1400 may further include a display 1414, such as a liquid crystal display (LCD), an organic light emitting diode (OLED), a flat panel display, a solid state display, a cathode ray tube (CRT), a projector, a printer or other now known or later developed display device for outputting determined information. The display 1414 may act as an interface for the user to see the functioning of the processor 1402, or specifically as an interface with the software stored in the memory 1404 or in the drive unit 1406.

Additionally, the computer system 1400 may include an input device 1412 configured to allow a user to interact with any of the components of system 1400. The input device 1412 may be a number pad, a keyboard, or a cursor control device, such as a mouse, or a joystick, touch screen display, remote control or any other device operative to interact with the system 1400.

The computer system 1400 may also include a disk or optical drive unit 1406. The disk drive unit 1406 may include a computer-readable medium 1422 in which one or more sets of instructions 1424, e.g. software, can be embedded. Further, the instructions 1424 may perform one or more of the methods or logic as described herein. The instructions 1424 may reside completely, or at least partially, within the memory 1404 and/or within the processor 1402 during execution by the computer system 1400. The memory 1404 and the processor 1402 also may include computer-readable media as discussed above.

The present disclosure contemplates a computer-readable medium 1422 that includes instructions 1424 or receives and executes instructions 1424 responsive to a propagated signal; so that a device connected to a network 235 may communicate voice, video, audio, images or any other data over the network 235. Further, the instructions 1424 may be transmitted or received over the network 235 via a communication interface 1418. The communication interface 1418 may be a part of the processor 1402 or may be a separate component. The communication interface 1418 may be created in software or may be a physical connection in hardware. The communication interface 1418 may be configured to connect with a network 235, external media, the display 1414, or any other components in system 1400, or combinations thereof. The connection with the network 235 may be a physical connection, such as a wired Ethernet connection or may be established wirelessly as discussed below. Likewise, the additional connections with other components of the system 1400 may be physical connections or may be established wirelessly. In the case of a service provider server 240, a third party server 250, an advertising services server 260, the servers may communicate with users 120A-N and the revenue generators 110A-N through the communication interface 1418.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 1422 may be a single medium, or the computer-readable medium 1422 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1422 may include a solid-state memory such as a memory card or other package that houses one or more non-volatile read-only memories. The computer-readable medium 1422 also may be a random access memory or other volatile re-writable memory. Additionally, the computer-readable medium 1422 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

What is claimed is:

1. A method for generating advertising creatives, comprising:
identifying an ad group of an advertiser;
identifying a first set of creative components relating to the ad group;
identifying a second set of creative components relating to the ad group;
identifying a set of destination URLs relating to the ad group;
matching each creative component in the first set of creative components to each creative component in the second set of creative components to create a set of matched groups of creative components; and
matching each matched group of creative components in the set of matched groups to each destination URL in the set of destination URLs to generate one or more advertising creatives.

2. The method of claim 1 wherein the first set of creative components comprises a set of advertisement titles relating to the ad group.

3. The method of claim 1 wherein the second set of creative components comprises a set of advertisement descriptions relating to the ad group.

4. The method of claim 3 wherein the advertisement descriptions comprise full advertisement descriptions and half advertisement descriptions.

5. The method of claim 1 wherein a creative component in the first set of creative components is based on a set of search terms bid on.

6. The method of claim 1 wherein a creative component in the second set of creative components is based on a set of search terms bid on.

7. The method of claim 1 wherein identifying a first set of creative components relating to the ad group further comprises processing the first set of creative components.

8. (canceled)

9. The method of claim 7 wherein processing the first set of creative components comprises substituting a set of consecutive characters within a creative component in the first set of creative components with a second set of consecutive characters.

10. The method of claim 1 wherein identifying a second set of creative components relating to the ad group further comprises processing the second set of creative components.

11. The method of claim 10 wherein processing the second set of creative components comprises modifying at least one of a word order, a punctuation, a spelling, a plurality, a grammar, and a capitalization of a creative component in the second set of creative components.

12. (canceled)

13. The method of claim 1 further comprising processing the one or more advertising creatives.

14. The method of claim 13 wherein processing the one or more advertising creatives further comprises modifying at least one of a word order, a punctuation, a spelling, a plurality, a grammar and a capitalization of the one or more advertising creatives.

15. (canceled)

16. The method of claim 13 wherein processing the one or more advertising creatives further comprises ranking each advertising creative in the one or more advertising creatives based on a relevance of each advertising creative to a keyword bid on for the ad group.

17. A method of generating creative components comprising:
identifying an ad group of an advertiser;
identifying a data relating to the ad group;
identifying a set of destination URLs referring to a set of web sites each containing a content relating to the ad group; and
generating one or more creative components based on the content of the each web site in the set of web sites.

18. The method of claim 17 wherein the data relating to the ad group comprises at least one of a name of the ad group, an advertisement title, an advertisement description, an advertisement half-description, and a search keyword bid on for the ad group.

19. The method of claim 17 further comprising processing the one or more creative components.

20. The method of claim 19 wherein processing the one or more creative components further comprises modifying at least one of a word order, a punctuation, a spelling, a plurality, a grammar, and a capitalization of the one or more creative components.

21. The method of claim 19 wherein processing the one or more creative components comprises replacing a set of consecutive characters within the one or more creative components with a second set of consecutive characters.

22. A system for generating advertising creatives, comprising:
a memory to store an ad group of an advertiser, a first set of creative components relating to the ad group, a second set of creative components relating to the ad group, a set of matched groups of creative components, a set of destination URLs relating to the ad group, and one or more advertising creatives; and
a processor operatively connected to the memory, which identifies the ad group, the first set of creative components related to the ad group, the second set of creative components related to the ad group and the set of destination URLs relating to the ad group, matches each creative component in the first set of creative components to each creative component in the second set of creative components to create a set of matched groups of creative components and matching each matched group of creative components in the set of matched groups of creative components to each destination URL in the set of destination URLs to generate one or more advertising creatives.

23. The system of claim 22 wherein the first set of creative components comprises a set of advertisement titles relating to the ad group.

24. The system of claim 22 wherein the second set of creative components comprises a set of advertisement descriptions relating to the ad group.

25. The system of claim 22 further comprising an interface operatively connected to the memory and the processor to communicate with the advertiser.

26. The system of claim 25 further comprising communicating the generated advertising creatives to the advertiser.

27. The system of claim 22 wherein the processor performs an editorial quick check on each advertising creative in the one or more advertising creatives.

28. The system of claim 22 wherein the processor ranks each advertising creative in the one or more advertising creatives based on a relevance of each advertising creative to a keyword bid on by the advertiser for the ad group.
